(19) United States
(12) Patent Application Publication
(10) Pub. No.: US 2024/0142716 A1
(43) Pub. Date: May 2, 2024

(54) FIBER CABLE AND PORT LOCKING ASSEMBLY

(71) Applicant: Green Lambda Corporation, Norman, OK (US)

(72) Inventors: Mohammad H. Raza, Norman, OK (US); Ahmed Arsalan, Norman, OK (US); Jose Pats, Norman, OK (US); Sang A Cooc, Norman, OK (US); Phuc Ly, Norman, OK (US); Robert O’Neil, Norman, OK (US)

(21) Appl. No.: 18/498,012

(22) Filed: Oct. 30, 2023

Related U.S. Application Data
(60) Provisional application No. 63/420,656, filed on Oct. 30, 2022.
(60) Provisional application No. 63/455,962, filed on Mar. 30, 2023.
(60) Provisional application No. 63/464,611, filed on May 7, 2023.
(60) Provisional application No. 63/521,861, filed on Jun. 19, 2023.
(60) Provisional application No. 63/532,237, filed on Aug. 11, 2023.

(51) Int. Cl. G02B 6/38

(52) U.S. Cl. CPC G02B 6/3831

(57) ABSTRACT

The present disclosure provides embodiments of assemblies where fiber cable connectors can be electronically locked to ports that receive the cable connectors. In one exemplary embodiment, port includes a locking assembly having an actuator assembly and a locking pin. The fiber cable connector includes an opening to receive the locking pin to selectively and releasably lock the fiber cable connector to the port.

### CROSS-REFERENCE TO RELATED APPLICATIONS

This application claims priority to co-pending U.S. Provisional Application No. 63/420,656, filed on Oct. 30, 2022, and co-pending U.S. Provisional Application No. 63/455,962, filed on Mar. 30, 2023, and co-pending U.S. Provisional Application No. 63/464,611, filed on May 7, 2023, and co-pending U.S. Provisional Application No. 63/521,861, filed on Jun. 19, 2023, and co-pending U.S. Provisional Application No. 63/532,237, filed on Aug. 11, 2023, each entitled “Fiber Cable and Port Locking Assembly” and each of which is incorporated herein in its entirety by reference.

### BACKGROUND

### Field

The present disclosure relates generally to fiber cable and port locking assemblies, and more particularly to assemblies where fiber cable connectors can be electronically locked and unlocked to ports or adapters that receive the fiber cable connectors.

### SUMMARY

The present disclosure includes embodiments of locking assemblies where fiber cable connectors can be electronically locked to and unlocked from fiber ports or adapters that receive the fiber cable connectors. The fiber ports or adapters include a locking member or assembly and the fiber connectors include a lock receiving member or assembly. For ease of description, the fiber ports or adapters may be collectively referred to herein as the “adapters” in the plural and the “adapter” in the singular. The fiber connectors may be referred to herein as the “connectors” in the plural and the “connector” in the singular. Non-limiting examples of the connectors and adapters contemplated include single fiber simplex and duplex connectors and adapters, and multi-fiber connectors and adapters. Non-limiting examples of single fiber simplex and duplex connectors and adapters include LC, SC, ST and FC, connectors and adapters. Non-limiting examples of multi-fibers connectors and adapters include MPO and MXC connectors and adapters.

In an exemplary embodiment, the locking assembly includes an actuator assembly or member and a locking pin. The fiber cable connectors include an opening to receive the locking pin to selectively and releasably lock the fiber cable connector to the port.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of an exemplary embodiment of a fiber cable connector and port assembly according to the present disclosure;

FIG. 2 is a perspective view of the fiber cable connector and port assembly of FIG. 1, illustrating of a fiber cable connector separated from the fiber adapter, and illustrating an exemplary embodiment of a fiber mating assembly;

FIG. 3 is an enlarged perspective view of the fiber mating assembly of FIG. 2, illustrating an actuator and locking pin of the fiber mating assembly with the locking pin in an unlocked position;

FIG. 4 is a side elevation view in partial cross-section of another exemplary embodiment of a fiber mating assembly according to the present disclosure, where the fiber mating assembly includes a solenoid and rod arrangement for moving a locking pin between the unlocked position and a locked position, and an opening in the fiber cable connector for receiving the locking pin;

FIG. 5 is side elevation view in partial cross-section of the locking assembly of FIG. 4, illustrating the locking pin in the locked position;

FIG. 6 is a perspective view of an exemplary embodiment of multiple fiber mating assemblies of FIG. 4 positioned on a platform;

FIG. 7 is a side elevation view in partial cross-section of one of the multiple fiber mating assemblies positioned on the platform of FIG. 6;

FIG. 8 is a side elevation view in partial cross-section of another exemplary embodiment of a fiber mating assembly and an exemplary embodiment of a fiber cable connector according to the present disclosure, where the fiber mating assembly includes a spring and locking pin arrangement for moving the locking pin between the unlocked position and a locked position, and an opening in the fiber cable connector for receiving the locking pin;

FIG. 9 is the side elevation view in partial cross-section of the locking assembly of FIG. 8, illustrating the locking pin in the locked position;

FIG. 10 is a side elevation view in partial cross-section of another exemplary embodiment of a fiber mating assembly and an exemplary embodiment of a fiber cable connector according to the present disclosure, where the fiber mating assembly includes a spring and locking arrangement for moving the locking pin between the unlocked position and the locked position, and an opening in the fiber cable connector for receiving the locking pin;

FIG. 11 is the side elevation view in partial cross-section of the locking assembly of FIG. 10, illustrating the locking pin in the locked position;

FIG. 12 is a perspective view of another exemplary embodiment of a fiber cable connector and port assembly according to the present disclosure;

FIG. 13 is an exploded perspective view of the fiber cable connector and port assembly of FIG. 12, illustrating an exemplary embodiment of an actuator assembly of a locking assembly, and illustrating paired cable connectors with an exemplary embodiment of a connector clip assembly;

FIG. 13A is a perspective view another exemplary embodiment of the fiber cable connector and port assembly that is similar to FIG. 13, and illustrating another exemplary embodiment of an actuator assembly of the locking assembly;

FIG. 14 is a perspective view of another exemplary embodiment of the fiber cable connector and port assembly that is similar to FIG. 13, and illustrating another exemplary embodiment of an actuator assembly of the locking assembly;

FIG. 15 is an exploded perspective view of another exemplary embodiment of the fiber cable connector and port assembly that is similar to FIG. 13, and illustrating another exemplary embodiment of a locking assembly;

FIG. 16 is a perspective view of the locking assembly of FIG. 15, illustrating a locking member in a locked position and a lock drive member in a neutral position;

FIG. 17 is the perspective view of the locking assembly of FIG. 16, illustrating the locking member moved to an unlocked position and the lock drive member being moved to a drive position;

FIG. 18 is a side elevation view in partial cross-section of the locking assembly of FIG. 15, illustrating a fiber mating assembly of the fiber cable connector and port assembly in the unlocked position;

FIG. 19 is a top plan view of the fiber cable connector and port assembly of FIG. 18, illustrating an actuator system for the fiber mating assembly of the fiber cable connector and port assembly;

FIG. 20 is a side elevation view in partial cross-section of the fiber cable connector and port assembly of FIG. 18, illustrating an exemplary embodiment of an arm locking assembly of the actuator system for the fiber mating assembly of the fiber cable connector and port assembly;

FIG. 21 is a top plan view of the fiber cable connector and port assembly of FIG. 20, illustrating the arm locking assembly and an exemplary embodiment of a lock release member of the actuator system of the fiber mating assembly;

FIG. 22 is a top plan view similar to FIG. 21, illustrating the arm locking assembly in an unlocked position;

FIG. 23 is a top perspective view of another exemplary embodiment of the fiber cable connector and port assembly according to the present disclosure;

FIG. 24 is an exploded perspective view of the fiber cable connector and port assembly of FIG. 23, illustrating the fiber mating assembly of the fiber cable connector and port assembly;

FIG. 25 is a top perspective view of a portion of the fiber mating assembly of FIG. 24;

FIG. 26 is a top plan view of the fiber cable connector and port assembly of FIG. 23;

FIG. 27 is another top plan view of fiber cable connector and port assembly of FIG. 23;

FIG. 28 is another top plan view of fiber cable connector and port assembly of FIG. 23;

FIG. 29 is another top plan view of fiber cable connector and port assembly of FIG. 23;

FIG. 30 is a top perspective view of another exemplary embodiment of a fiber cable connector and port assembly according to the present disclosure, illustrating another exemplary embodiment of a fiber mating assembly and another exemplary embodiment an actuator system of the fiber mating assembly;

FIG. 31 is an exploded top perspective view of a portion of the fiber mating assembly of FIG. 30;

FIG. 32 is a top plan view of the fiber cable connector and port assembly of FIG. 30, illustrating the fiber mating assembly in an unlocked position;

FIG. 33 is a top plan view of the fiber cable connector and port assembly of FIG. 30, illustrating the fiber mating assembly in a locked position;

FIG. 34 is a top perspective view of another exemplary embodiment of a fiber cable connector and port assembly according to the present disclosure, illustrating another exemplary embodiment of a fiber mating assembly and another exemplary embodiment an actuator system of the fiber mating assembly;

FIG. 35 is an exploded top perspective view of the fiber cable connector and port assembly of FIG. 34;

FIG. 36 is a side elevation view in partial cross-section of the fiber cable connector and port assembly of FIG. 34;

FIG. 37 is another side elevation view in partial cross-section of the fiber cable connector and port assembly of FIG. 34;

FIG. 38 is a perspective view of another exemplary embodiment of a fiber cable connector and port assembly according to the present disclosure;

FIG. 39 is an exploded top perspective view of the fiber cable connector and port assembly of FIG. 38;

FIG. 40 is a side elevation view in partial cross-section of the fiber cable connector and port assembly of FIG. 38;

FIG. 41 is another side elevation view in partial cross-section of the fiber cable connector and port assembly of FIG. 38;

FIG. 42 is another side elevation view in partial cross-section of the fiber cable connector and port assembly of FIG. 38;

FIG. 43 is a top perspective view of another exemplary embodiment of a fiber cable connector and port assembly according to the present disclosure;

FIG. 44 is a bottom perspective view of the fiber cable connector and port assembly of FIG. 43;

FIG. 45 is a perspective view of a slider of a fiber mating assembly of the fiber cable connector and port assembly of FIG. 43;

FIG. 46 is a perspective view of a locking arm of a fiber mating assembly of the fiber cable connector and port assembly of FIG. 43;

FIG. 47 is an enlarged bottom perspective view of a portion of the fiber cable connector and port assembly of FIG. 43;

FIG. 48 is another enlarged bottom perspective view of a portion of the fiber cable connector and port assembly of FIG. 43;

FIG. 49 is a top perspective view of another exemplary embodiment of a fiber cable connector and port assembly according to the present disclosure;

FIG. 50 is an exploded top perspective view of the fiber cable connector and port assembly of FIG. 49;

FIG. 51 is a side elevation view in partial cross-section of the fiber cable connector and port assembly of FIG. 49;

FIG. 52 is another side elevation view in partial cross-section of the fiber cable connector and port assembly of FIG. 49;

FIG. 53 is block diagram for a controller circuit used to control the operation of the actuators of the fiber cable connector and port assemblies of the present disclosure;

FIG. 54 is a bottom perspective view of another exemplary embodiment of a fiber cable connector and port assembly according to the present disclosure;

FIG. 55 is a bottom perspective view of the fiber cable connector and port assembly of FIG. 54, illustrating a fiber mating assembly removed from a housing of the fiber cable connector and port assembly;

FIG. 56 is an enlarged perspective view of the fiber mating assembly of FIG. 55;

FIG. 57 is a cross-sectional view of a portion of the fiber mating assembly of FIG. 56, taken from line 57-57, illustrating the fiber mating assembly in an unlocked position;

FIG. 58 is the cross-sectional view of a portion of the fiber mating assembly of FIG. 57, illustrating the fiber mating assembly in a locked position;

FIG. 59 is an enlarged perspective view of another exemplary embodiment of the fiber mating assembly according to the present disclosure;

FIG. 60 is a cross-sectional view of a portion of the fiber mating assembly of FIG. 59, taken from line 60-60, illustrating the fiber mating assembly in an unlocked position;

FIG. 61 is the cross-sectional view of a portion of the fiber mating assembly of FIG. 60, illustrating the fiber mating assembly in a locked position;

FIG. 62 is block diagram for another exemplary embodiment of a controller circuit used to control the operation of the actuators of the fiber cable connector and port assemblies of the present disclosure;

FIG. 63 is a bottom perspective view of another exemplary embodiment of the fiber cable connector and port assembly according to the present disclosure;

FIGS. 64-68 are a schematic representations of a connector blocking feature of the fiber cable connector and port assemblies of the present disclosure;

FIG. 69 is a bottom perspective view of another exemplary embodiment of the fiber cable connector and port assembly according to the present disclosure;

FIG. 70 is a bottom perspective view of the fiber cable connector and port assembly of FIG. 69, illustrating a fiber mating assembly removed from a housing of the fiber cable connector and port assembly;

FIG. 71 is an enlarged perspective view of the fiber mating assembly of FIG. 70;

FIG. 72 is a perspective view of an exemplary embodiment of a slide used in the fiber mating assembly of FIG. 71;

FIG. 73 is a perspective view of an exemplary embodiment of a slide used in the fiber mating assembly of FIG. 71;

FIG. 74 is a perspective view of an exemplary embodiment of a slide used in the fiber mating assembly of FIG. 71;

FIG. 75 is another enlarged perspective view of the fiber mating assembly of FIG. 70;

FIG. 76 is another enlarged perspective view of the fiber mating assembly of FIG. 70;

FIG. 77 is another enlarged perspective view of the fiber mating assembly of FIG. 70; and

FIG. 78 is an enlarged perspective view of the fiber mating assembly of FIG. 70.

### DETAILED DESCRIPTION

The present disclosure provides embodiments of embodiments of fiber mating assemblies where fiber cable connectors can be electronically locked to fiber cable ports or adapters that receive the fiber cable connectors. For ease of description, the fiber cable connectors may also be referred to herein as the “connector” in the singular and the “connectors” in the plural. The fiber cable ports or adapters may also be referred to collectively herein as the “port” in the singular and the “ports” in the plural. The fiber mating assemblies may also be referred to herein as the “assembly” in the singular and the “assemblies” in the plural. Each fiber mating assembly includes a fiber cable connector portion and a corresponding fiber cable port portion.

The connectors and ports contemplated herein may be multi-fiber connectors and ports, or single fiber connectors and ports, including paired single fiber connectors and ports. Each multi-fiber connector contemplated herein is capable of mating with a corresponding multi-fiber port, and each single fiber connector contemplated herein is capable of mating with a corresponding single fiber port. Non-limiting examples of multi-fiber connectors and ports include Multi-fiber Push On (“MPO”) type connectors and ports, which are sometimes called MTP connectors and ports, MXC connectors and ports, and other connectors and ports capable of trunking more than one fiber in a single jacket. Non-limiting examples of single fiber connectors and ports include LC, SC, FC/PC connectors and ports, and other connector and port types that terminate single fiber cables. The ports contemplated by the present application include adapters and Small Form Factor Pluggable (SFP) ports.

The fiber mating assembly according to the present disclosure includes a connector portion and a port portion. The connectors are operatively connected to fiber optic cables, and the ports may be part of different components within a datacenter, such as patch panels, servers, switches and storage devices. The connectors and ports are configured to mate together. Each connector may be a male connector or a female connector, and each port may be a female port or a male port.

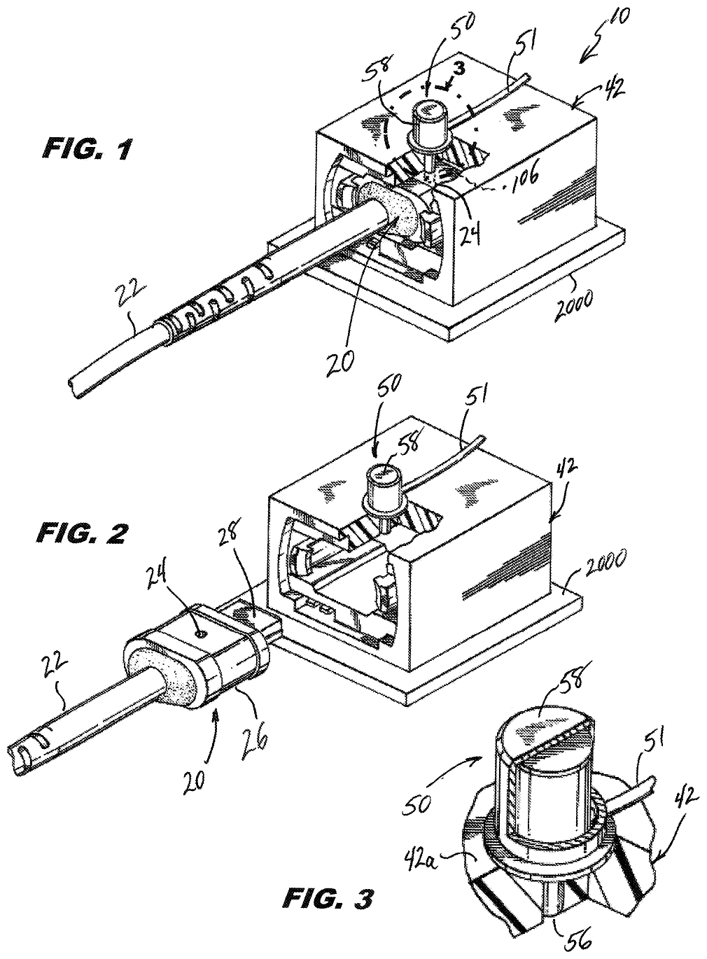

In the exemplary embodiment of FIGS. 1-3, the fiber mating assembly 10 includes a multi-fiber connector 20 and a multi-fiber port 40. The multi-fiber connector 20 is similar to a known MPO connector that can be operatively connected to a multi-fiber cable 22, except the connector 20 includes a locking opening 24. The locking opening 24 is formed into a housing 26 of the connector 20 that typically includes a ferrule 28. The locking opening 24 is configured and dimensioned to receive a locking member 56 of a locking assembly 50 of the port 40 so that the locking member 56 when in a locked position prevents the connector 20 from being removed from the port 40.

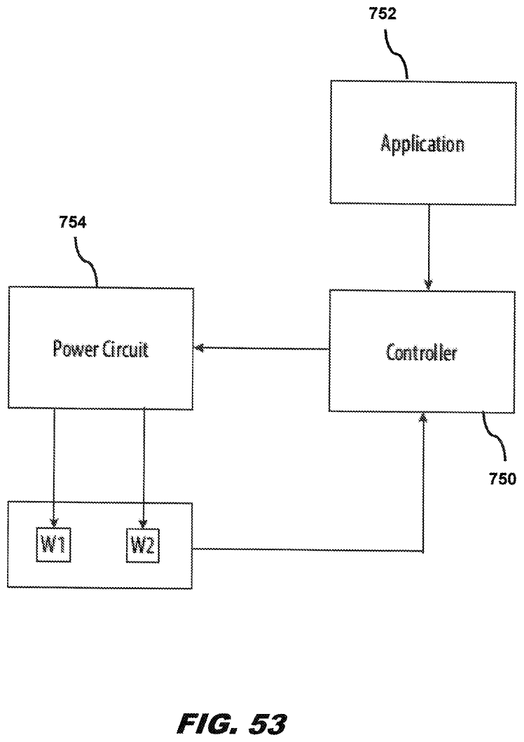

The multi-fiber port 40 is similar to a known MPO port that can be operatively connected to a multi-fiber connector 20, except the port 40 includes the locking assembly 50 mounted to or built into the port 40. For example, the locking assembly 50 may be mounted to a housing 42 of the port 40. As another example, the locking assembly 50 may be built into or integral the housing 42 of the port 40. The port 40 may be mounted to a platform 2000. Non-limiting examples of a platform 2000 include printed circuit boards, surfaces of the housing 42 and brackets within a housing (not shown) of components within a datacenter. The locking assembly 50 is an electronically or electrically controlled assembly where a controller 750, seen in FIG. 53, either internal or external to a housing of components within a datacenter, controls the operation of the locking assembly 50 via a cable 51.

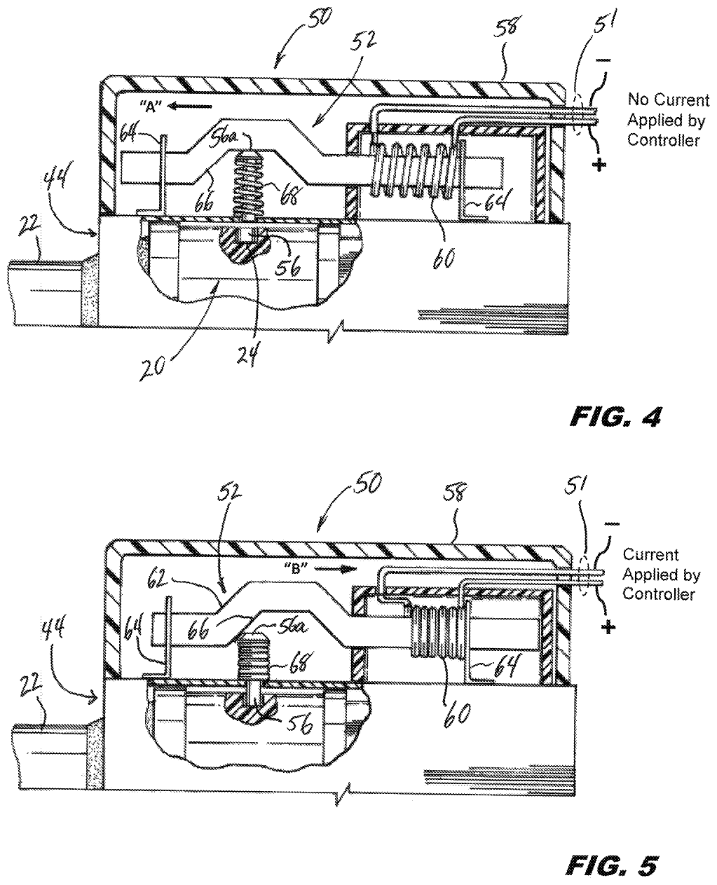

The locking assembly 50 includes an actuator 52 and a locking member 56 within a housing 58. The locking assembly 50 is mounted to an exterior surface 42a of the housing 42 of the port 40. However, the present disclosure contemplates that the locking assembly 50 may be within the housing 42 of the port 40. The actuator 52 may be an assembly of two or more components or the actuator 52 may be a single component or member. In this exemplary embodiment, the actuator 52 is a single member and the locking member 56 is a pin or rod. The actuator 52 is electrically and/or operatively connected to the controller 750 so that the controller can apply a signal that activates the actuator 52 to move the locking member 56 between an unlocked position and a locked position. In the unlocked position, the locking member 56 is retracted from an opening 44 in the port 40, as shown in FIG. 3. In the locked position, the locking member 56 extends into the opening 44 in the port 40, as shown in FIG. 1. In the exemplary embodiment of FIGS. 1-3, the actuator 52 is a push-pull solenoid and the locking member 56 is the rod of the push-pull solenoid. An example of a push-pull solenoid is the 6873K3 Compact Linear Solenoid distributed by McMaster-Carr, Trenton, NJ. In the exemplary embodiment of FIGS. 1-3, the controller 750 can be instructed to send a signal, e.g., current, via cable 51 to the push-pull solenoid 52 to move the locking member 56 to the locked position. Moving the locking member 56 to the locked position so that the locking member 56 is inserted into the locking opening 24 of the connector 20, locks the connector 20 to the port 40. Locking the connector 20 to the port 40 prevents the connector 20 from being removed from the port 40. In addition, the controller 750 can be instructed to send a signal, e.g., current, via cable 51 to the push-pull solenoid 52 to move the locking member 56 to the unlocked position removes the locking member 56 is removed from the locking opening 24. Moving the locking member 56 to the unlocked position thus unlocks the connector 20 from the port 40 allowing the connector 20 to be removed from the port 40.

Referring to FIGS. 4 and 5, another exemplary embodiment of the actuator 52 of the locking assembly 50 is shown. In this exemplary embodiment, the actuator 52 is an assembly of two or more components that includes a push and/or pull member 60 secured to a rail 62 that is held in position within the housing 58 by rail brackets 64. The actuator 52 is electrically and/or operatively connected to the controller 750 so that the controller can apply a signal, e.g., a current, via cable 51 that activates the actuator 52 to move the locking member 56 between the unlocked position and the locked position. As described above, in the unlocked position, the locking member 56 is retracted from an opening 44 in the port 40, as shown in FIG. 4. And, in the locked position, the locking member 56 extends into the opening 44 in the port 40, as shown in FIG. 5.

In the exemplary embodiment shown, the push and/or pull member 60 is a spring made of a material having shape memory properties, such as a shape memory alloy. Non-limiting examples of shape memory alloys include Nitinol, Flexinol® and Muscle Wire. For this exemplary embodiment, the push and/or pull member will be referred to as the spring 60. The spring 60 is secured to the rail 62 such that the spring 60 can move the rail 62 in the direction of arrows “A” and “B” shown in FIGS. 4 and 5. The rail 62 is held in position within the housing 58 by rail brackets 64 so that the rail 62 is movable relative to the fixed rail brackets 64. The rail 62 has a camming surface 66 that is configured to engage a head 56a of the locking member 56. More specifically, the rail 62 has an offset with a high area that permits the locking member 56 to move to the unlocked position, seen in FIG. 4, and a low area that holds the locking member 56 in the locked position, seen in FIG. 5. The camming surface 66 is used to move the locking member 56 from the unlocked position to the locked position. In this configuration, with the spring 60 unheated, e.g., no current is applied to the spring 60 via cable 51, the spring extends to its normal position moving the rail 62 in the direction of arrow “A” so that the locking member 56 is within the high area of the rail 62. With the locking member 56 within the high area of the rail 62, a biasing member 68, e.g., a compression spring, biases the locking member 56 to the unlocked position. When the spring 60 is heated, e.g., a current is applied to the spring 60 via cable 51, the spring contracts or compresses moving the rail 62 in the direction of arrow “B” to the locked position. As the rail 62 moves in the direction of arrow “B,” the head 56a of the locking member 56 engages the camming surface 66 of the rail 62 so that the camming surface 66 moves the locking member 56 to the locked position. In this exemplary embodiment, the controller 750 can be instructed to send a signal, e.g., a current, to the spring 60 heating the spring causing the spring 60 to move in the direction of arrow “B,” which moves the locking member 56 to the locked position. Moving the locking member 56 to the locked position inserts the locking member 56 into the locking opening 24 in the connector 20 so that the connector 20 is locked to the port 40. Locking the connector 20 to the port 40 prevents the connector 20 from being removed from the port 40. When the locking member 56 is in the locked position, the controller 750 can be instructed to remove the signal from the spring 60 so that the spring 60 cools. As the spring 60 cools, the rail 62 moves in the direction of arrow “A” permitting the locking member 56 to move to the unlocked position via the biasing force of the biasing member 68. With the locking member 56 in the unlocked position, the connector 20 is unlocked from the port 40 allowing the connector 20 to be removed from the port 40 or permits a connector 20 to be inserted into the port 40.

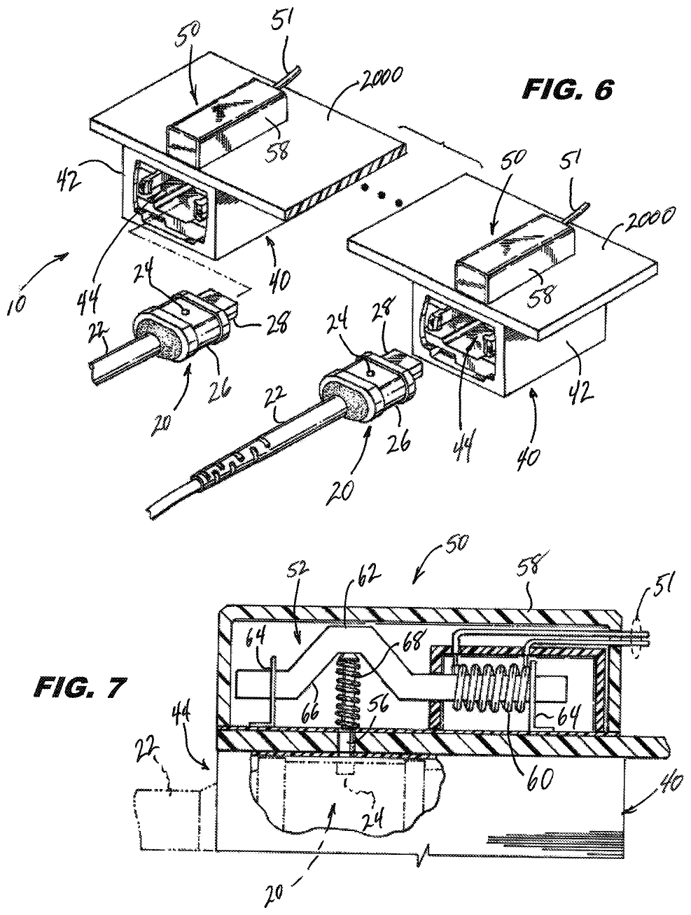

Referring to FIGS. 6 and 7, multiple locking assemblies 50 may be arranged on a platform 2000 in series, where one locking assembly 50 is associated with one port 40 of a series of ports 40 arranged on the platform 2000. The controller 750 can be programmed to control the actuator 52 of each locking assembly 50 separately so that each actuator 52 can be in the unlocked or locked position at the same time. In addition, the controller 750 can be programmed to control the actuator 52 of each locking assembly 50 separately so that each actuator 52 can be in the unlocked or locked position independent of the other actuators 52. Movement of the actuators 52 and the locking members 56 within the housings 58 of the locking assembly 50 is the same as that described above.

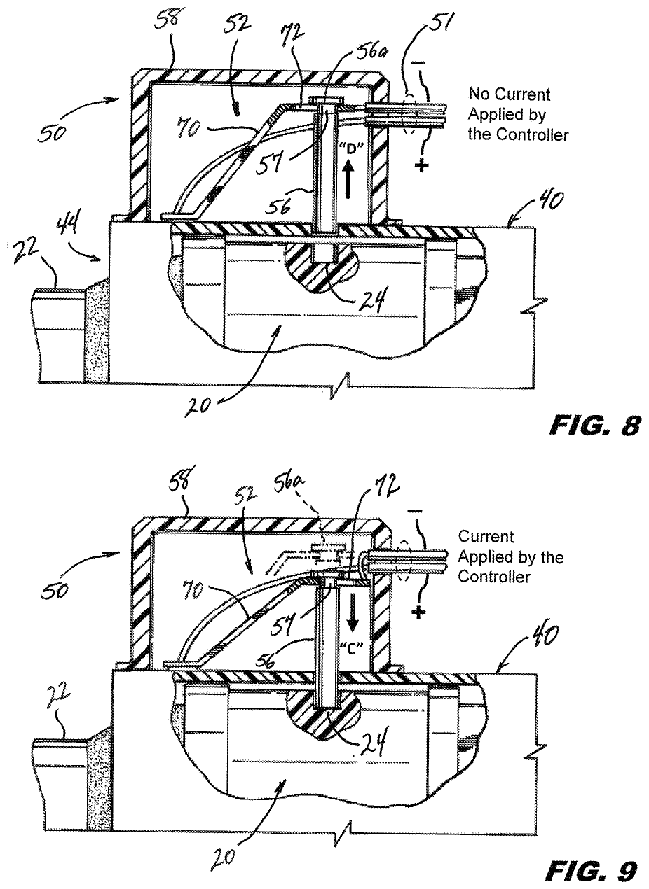

Referring to FIGS. 8 and 9, another exemplary embodiment of the actuator 52 is shown. The actuator 52, in this exemplary embodiment, is a single member. The actuator 52 is electrically and/or operatively connected to the controller 750 so that the controller can apply a signal that activates the actuator 52 to move the locking member 56 between the unlocked position and the locked position. In the unlocked position, the locking member 56 is retracted from the opening 44 in the port 40, as shown in FIG. 8. In the locked position, the locking member 56 extends into the opening 44 in the port 40, as shown in FIG. 9. In the exemplary embodiment of FIGS. 8 and 9, the actuator 52 includes a push and/or pull member 70 a bi-metal strip 70 coupled to the locking member 56. In the exemplary embodiment shown, the push and/or pull member 70 is a bi-metal strip having shape memory properties, such as a shape memory alloys. For this exemplary embodiment, the push and/or pull member will be referred to as the bi-metal strip 70. More specifically, the head 56a of the locking member 56 is larger in size than the rest of the locking member 56, and an area of the locking member 56 adjacent the head 56a includes a notch 57. In addition, the bi-metal strip 70 include a slot 72 that fits within the notch 57 coupling the bi-metal strip 70 to the locking member 56. In this configuration, when the bi-metal strip 70 moves the locking member 56 between the unlocked and locked positions, the bi-metal strip 70 is movable relative to the notch 57. In this exemplary embodiment, the controller 750 can be instructed to send a signal, e.g., a current, to the bi-metal strip 70 heating the bi-metal strip causing the bi-metal strip 70 to move in the direction of arrow “C.” Moving the bi-metal strip 70 in the direction of arrow “C” causes the locking member 56 to move from the unlocked position, seen in FIG. 8, to the locked position, seen in FIG. 9. As the bi-metal strip 70 moves in the direction of arrow “C,” the bi-metal strip 70, the notch 57 moves within the slot 72 to move the locking member along a substantially linear path between the unlocked and locked positions. When the locking member 56 is in the locked position, a distal end of the locking member 56 is inserted into the locking opening 24 of the connector 20 locking the connector to the port 40. With the connector 20 locked to the port 40, the connector 20 is prevented from being removed from the port 40. When the locking member 56 is in the locked position, the controller 750 can be instructed to remove the signal from the bi-metal strip 70 so that the bi-metal strip 70 cools. As the bi-metal strip 70 cools, the bi-metal strip moves in the direction of arrow “D” causing the locking member 56 to move to the unlocked position. With the locking member 56 in the unlocked position, the distal end of the locking member 56 is removed from the locking opening 24 thus unlocking the connector 20 from the port 40 and allowing the connector 20 to be removed from the port 40 or permitting a connector 20 to be inserted into the port 40.

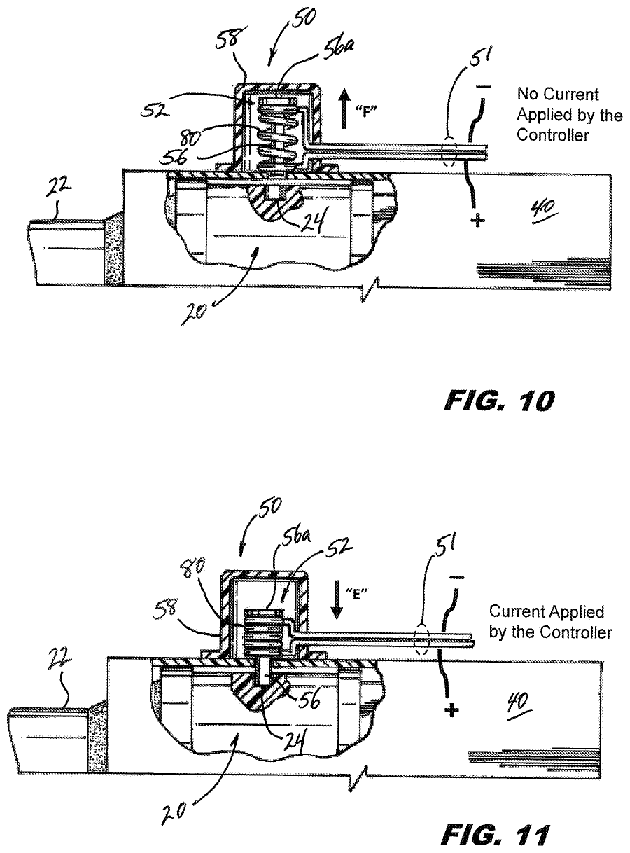

Referring to FIGS. 10 and 11, another exemplary embodiment of the actuator 52 of the locking assembly 50 is shown. In this exemplary embodiment, the actuator 52 is a single member. The actuator 52 is electrically and/or operatively connected to the controller 750, seen in FIG. 53, so that the controller can apply a signal, e.g., a current, that activates the actuator 52 to move the locking member 56 between the unlocked and locked positions. In the unlocked position, the locking member 56 is retracted from an opening 44 in the port 40, as shown in FIG. 10. In the locked position, the locking member 56 extends into the opening 44 in the port 40, as shown in FIG. 11. In the exemplary embodiment of FIGS. 10 and 11, the actuator 52 is a push and/or pull member 80. A non-limiting example of a push and/or pull member 80 is a spring made of a material having shape memory properties, such as a shape memory alloy. Non-limiting examples of shape memory alloys include Nitinol, Flexinol® and Muscle Wire. For this exemplary embodiment, the push and/or pull member will be referred to as the spring 80. The spring 80 is secured to the locking member 56 such that the spring 80 can move the locking member 56 in the directions of arrows “E” and “F” shown in FIGS. 10 and 11. In this exemplary embodiment, the controller 750 can be instructed to send a signal, e.g., a current, to the spring 80 heating the spring causing the spring 80 to move in the direction of arrow “E.” Moving the spring 80 in the direction of arrow “E” compresses the spring 80 causing the locking member 56 to move from the unlocked position, seen in FIG. 10, to the locked position, seen in FIG. 11. When the locking member 56 is in the locked position, the distal end of the locking member 56 is inserted into the locking opening 24 locking the connector 20 to the port 40. With the connector 20 locked to the port 40, the connector 20 is prevented from being removed from the port 40. When the locking member 56 is in the locked position, the controller 750 can be instructed to remove the signal from the spring 80 so that the spring 80 cools. As the spring 80 cools, the spring expands, moves in the direction of arrow “F,” back to its normal position causing the locking member 56 to move to the unlocked position. In the unlocked position, the distal end of the locking member 56 is removed from the locking opening 24 unlocking the connector 20 from the port 40 permitting the connector 20 to be removed from the port 40 or permitting a connector 20 to be inserted into the port 40.

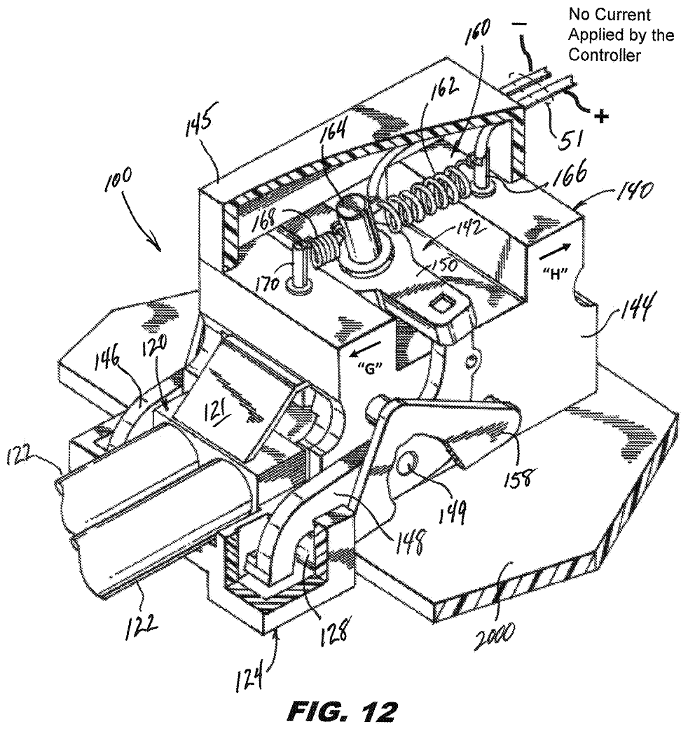

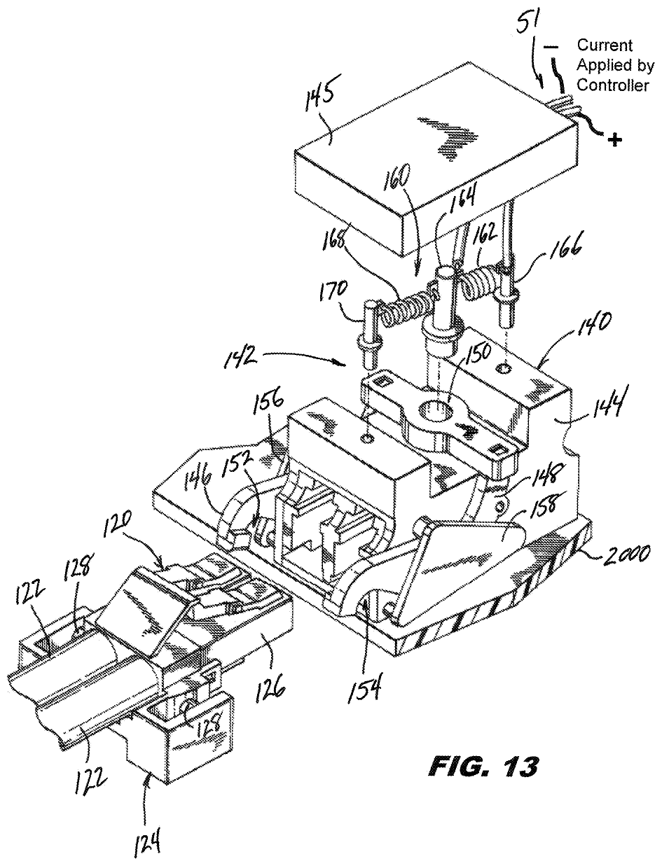

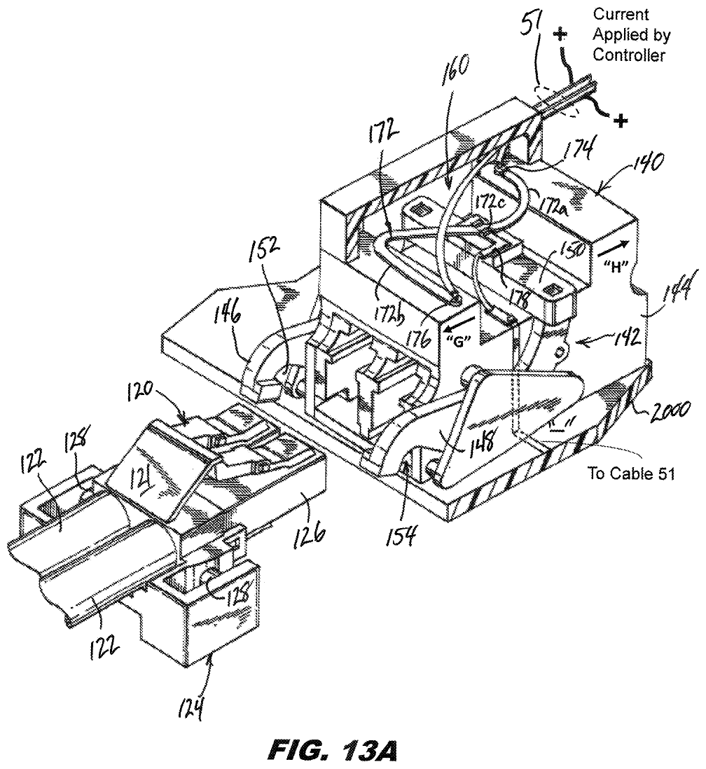

Referring to FIGS. 12, 13 and 13A, another exemplary embodiment of the fiber mating assembly is shown. In this embodiment, the fiber mating assembly 100 includes a connector 120 and a port 140. The connector 120 is a paired single fiber connector, and the port 140 is a paired single fiber port. The connector 120 is similar to known paired LC connectors that are operatively connected to single fiber optic cables 122, except the connector 120 includes a clip member 124. The clip member 124 may be integrally or monolithically formed into a housing 126 of the connector 120, or the clip member 124 may be releasably secured to the housing 126 of the connector 120 using for example a snap-fit connections, or the clip member 124 may be permanently secured to the housing 126 of the connector 120 using for example welds, adhesives or mechanical fasteners. In the embodiment shown, the clip member 124 includes one or more locking members 128 that are configured and dimensioned to be captured by a locking assembly 142 of the port 140 as described below. In a non-limiting example, the one or more locking members 128 may be pins within the clip member 124 as shown in FIG. 12. It is noted that the one or more locking members 128 may be part of the locking assembly 142 or the one or more locking members 128 may be separate components. The port 140 is similar to known paired LC ports that can be operatively connected to a paired fiber connector 120, except the port 140 includes the locking assembly 142 that may be integrally or monolithically formed into a housing 144 of the port 140, or the locking assembly 142 may be releasably or permanently secured to the housing 144 of the port 140. The housing 144 may have a cover 145 provided to cover at least a portion of the locking assembly 142. The port 140 may be mounted to a platform 2000. Non-limiting examples of a platform include printed circuit boards, surfaces of a housing or brackets within a housing of components within a datacenter.

Continuing to refer to FIGS. 12, 13 and 13A, the locking assembly 142 includes a first locking arm 146, a second locking arm 148, a connecting arm 150 and an actuator 160. The connecting arm 150 has a first end connected to the first end of the first locking arm 146, and the connecting arm 150 has a second end connected to a first end of the second locking arm 148. In this configuration, the connecting arm 150 extends from a first side of the housing 144 of the port 140 across to the second side of the housing 144. A portion, e.g., a central portion, of the first locking arm 146 is pivotably secured to the first side of the housing 144 via a pivot pin (not shown), and a second end of the first locking arm 146 includes locking notch 152. The first locking arm 146 may have a cover 156 covering the pivot point of the first locking arm 146 to help avoid interference with the operation of the first locking arm 146. Similarly, a portion, e.g., a central portion, of the second locking arm 148 is pivotably secured to the second side of the housing 144 via pivot pin 149, and a second end of the second locking arm 148 includes locking notch 154. The second locking arm 148 may have a cover 158 covering the pivot point of the second locking arm 148 to help avoid interference with the operation of the second locking arm 148. It is noted that the pivot pin pivotably securing the first locking arm 146 to the housing 144 is the same as the pivot pin 149. It is also noted that the first locking arm 146 may be substantially the same as the second locking arm 148. The locking notches 152 and 154 are configured to receive the locking members 128 of the clip member 124 of the connector 120 so that the locking members 128 are captured within the locking notches 152 and 154 such that the fiber mating assembly 100 is in a locked position where the connector 120 is prevented from being removed from the port 140.

Continuing to refer to FIGS. 12 and 13, another exemplary embodiment of the actuator 160 is shown. The actuator 160 is an electronically controlled assembly or member where a controller 750, seen in FIG. 53, either internal or external to a housing of components within a datacenter, controls the operation of the actuator 160. More specifically, the actuator 160 is used to move the locking arms 146 and 148 of the locking assembly 142 between an unlocked position, seen in FIG. 13, and a locked position, seen in FIG. 12. The actuator 160 may be an assembly of two or more components or the actuator 160 may be a single component or member. In the exemplary embodiment shown in FIGS. 12 and 13, the actuator 160 is an assembly of two or more components that includes a push and/or pull member 162 and a biasing member 168. In the exemplary embodiment shown, the push and/or pull member 162 is a spring made of a material having shape memory properties, such as a shape memory alloy. Non-limiting examples of shape memory alloys include Nitinol, Flexinol® and Muscle Wire. For this exemplary embodiment, the push and/or pull member will be referred to as the spring 162. The spring 162 has a first end secured to a central mounting post 164 and a second end secured to a mounting post 166 that is secured to and extends from an exterior surface of a rear portion of the housing 144. The central mounting post 164 is secured to and extends from the connecting arm 150 so that as the central mounting post 164 moves, the connecting arm 150 moves. The biasing member 168 has a first end secured to the central mounting post 164 and a second end secured to a mounting post 170 that is secured to and extends from an exterior surface of a front portion of the housing 144. The actuator 160 is shown as being on the exterior of the housing 144 of the port 140. However, the present disclosure contemplates that the actuator 160 may be within the housing 144 of the port 140. The mounting posts 164, 166 and 168 may be made of an electrically conductive material or a non-conductive or electrically insulating material.

The biasing member 168 may be a compression spring or other structure that normally applies a pulling force on the central mounting post 164 and connecting arm 150 in the direction of arrow “G.” This pulling force on the connecting arm 150 moves, e.g., pivots, the locking arms 146 and 148 to the locked position where the locking notches 152 and 154 can receive the locking members 128 of the clip member 124 of the connector 120. It is noted that as the biasing member 168 applies pulling force on the central mounting post 164, the spring 162 expands, as shown in FIG. 12. When the locking members 128 are captured within the locking notch 152 of the locking arm 146 and the locking notch 154 of the locking arm 148, the locking assembly 142, and thus the fiber mating assembly 100, is in the locked position. With the fiber mating assembly 100 in the locked position, the connector 120 is prevented from being removed from or inserted into the port 140.

As noted, the actuator 160 is electrically and/or operatively connected to the controller 750 so that the controller can apply a signal, e.g., a current, via cable 51 that activates the spring 162 of the actuator 160. Thus, to move the locking assembly 142 and thus the fiber mating assembly 100 from the locked position to the unlocked position, the controller 750 applies a signal, e.g., a current, to activate the spring 162. Activating the spring 162 heats the spring causing the spring to compress, seen in FIG. 13. Compressing the spring 162 applies a pulling force on the connecting arm 150 in the direction of arrow “H.” The pulling force of the spring 162 is sufficient to overcome the pulling force applied by the biasing member 168 so that the connecting arm 150 is pulled in the direction of arrow “H.” Movement of the connecting arm 150 in the direction of arrow “H” moves, e.g., pivots the locking arms 146 and 148 to the unlocked position. In the unlocked position, the first locking arm 146 and the second locking arm 148 are pivoted so that the locking notches 152 and 154 release the locking members 128 of the clip member 124. With the locking assembly 142, and thus the fiber mating assembly 100, in the unlocked position, permitting the connector 120 to be removed from the port 140 or permitting a connector 120 to be inserted into the port 40. With the connector 120 removed from the port 140, the controller 750 can remove the signal, e.g., remove the current, activating the spring 162 so that the spring 162 cools. As the spring 162 cools, the pulling force applied by the spring 162 on the connecting arm 150 reduces. When the pulling force applied by the spring 162 is no longer sufficient to overcome the pulling force applied by the biasing member 168, the pulling force of the biasing member 168 on the connecting arm 150 moves, e.g., pivots, the locking arms 146 and 148 to the locked position as described above. In the locked position, the first locking arm 146 and the second locking arm 148 are pivoted so that the locking notches 152 and 154 can capture the locking members 128 of the clip member 124. In the locked position, the connector 120 is prevented from being removed from or inserted into the port 140.

In the exemplary embodiment of FIGS. 12 and 13A, the fiber mating assembly is substantially the same as the fiber mating assembly 100 described with reference to FIGS. 12 and 13 above, such that like reference numbers are used for like elements. Except in this exemplary embodiment, the actuator 160 is a single component or member, namely push and/or pull member 172. The push and/or pull member 162 shown is a flat Z-shaped spring made of a material having shape memory properties, such as a shape memory alloy. Non-limiting examples of shape memory alloys include Nitinol, Flexinol® and Muscle Wire. For this exemplary embodiment, the push and/or pull member will be referred to as the spring 172. The spring 172 is a two-way shape-memory alloy having two portions 172a and 172b. The first portion 172a has an end connected to the first terminal 174, and the second portion 172b has an end connected to the second terminal 176. A junction 172c between the first portion 172a and the second portion 172b is connected to a third terminal 178. The first terminal 174 is secured to and extends from an exterior surface of the rear portion of the housing 144. The second terminal 176 is secured to and extends from an exterior surface of the front portion of the housing 144. The third terminal 178 is secured to the connecting arm 150. The cable 51 has a first wire electrically connected to the first terminal 174, a second wire electrically connected to the second terminal 176, and a third wire electrically connected to third terminal 178. In operation, when the controller 750 activates, e.g. applies a current to, the first portion 172a of the spring 172, the first portion 172a of the spring 172 pulls the connecting arm 150 in the direction of arrow “H” to move the first locking arm 146 and the second locking arm 148 of the locking assembly 142 to the unlock position, which is described above with reference to FIGS. 12 and 13. Further, when the controller 750 activates, e.g. applies a current to, the second portion 172b of the spring 172, the second portion 172b of the spring 172 pulls the connecting arm 150 in the direction of arrow “G” to move the first locking arm 146 and the second locking arm 148 of the locking assembly 142 to the locked position, which is described above with reference to FIGS. 12 and 13.

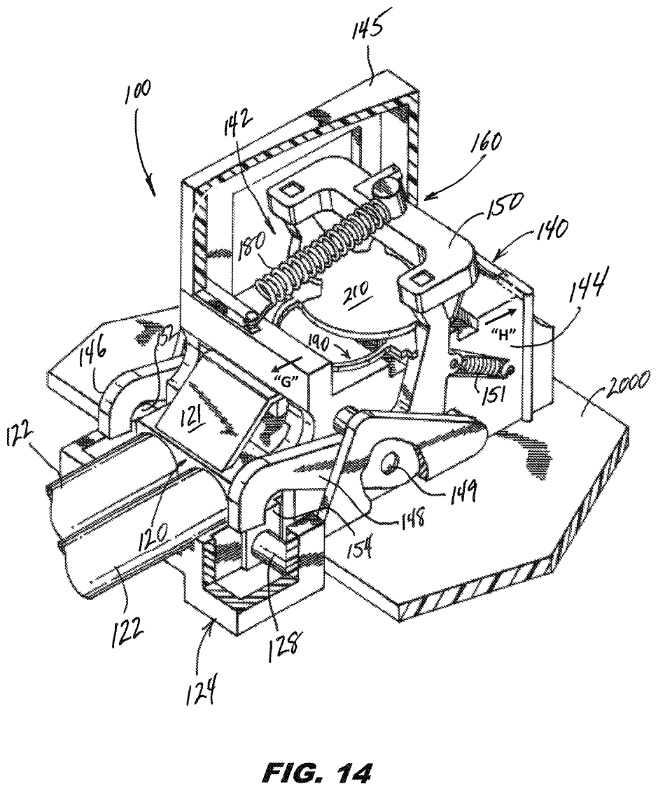

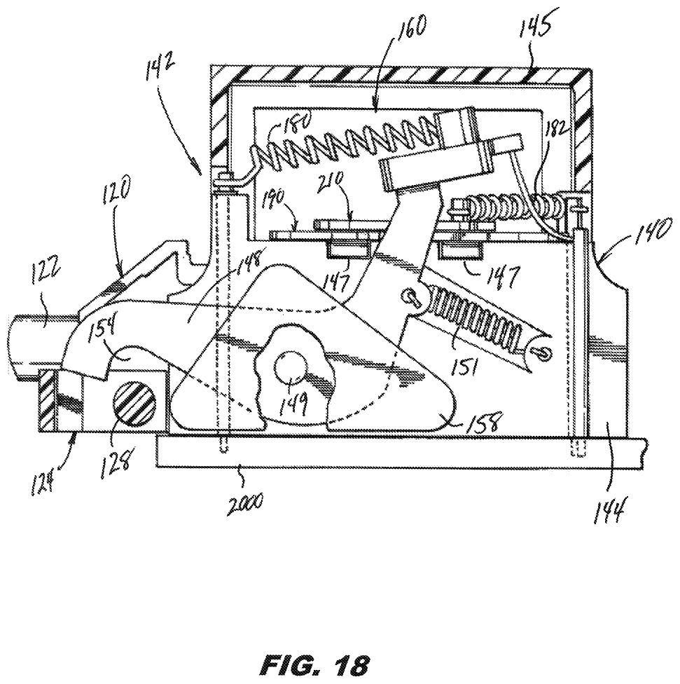

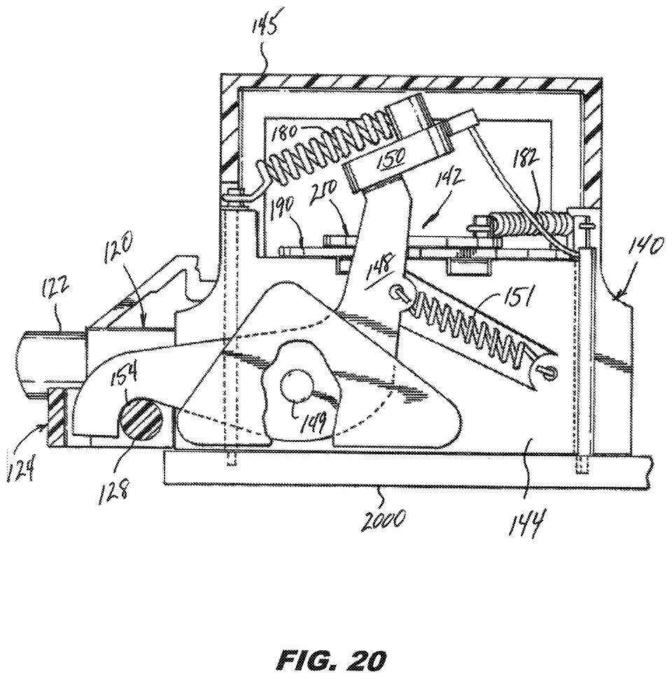

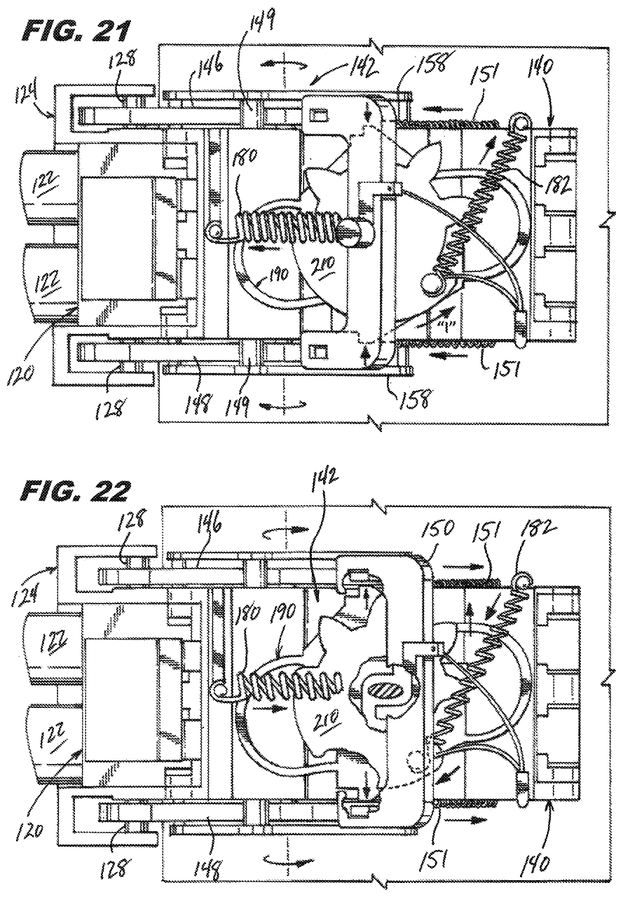

Referring now to FIGS. 14-22, another exemplary embodiment of the fiber mating assembly is shown. In this embodiment, the fiber mating assembly 100 includes a connector 120 and a port 140 as described above, such that like reference numbers are used for like elements and descriptions thereof are not repeated. The port 140 includes the locking assembly 142 that includes the first locking arm 146, the second locking arm 148, the connecting arm 150 and the actuator 160. The locking assembly 142 is an electronically controlled member where a controller 750, seen in FIG. 53, either internal or external to a housing of components within a datacenter, controls the operation of the locking assembly 142. More specifically, the actuator 160 is used to move the locking arms 146 and 148 of the locking assembly 142 between an unlocked position, seen in FIGS. 14 and 18, and a locked position, seen in FIG. 20. The actuator 160 may be an assembly of two or more components or the actuator 160 may be a single component or member. In this exemplary embodiment, the actuator 160 is an assembly of two or more components that includes a first push and/or pull member 180, a second push and/or pull member 182, arm locking member 190 and lock release member 210. At least a portion of the locking assembly 142 and the actuator 160 are mounted to an exterior surface of the housing 144 of the port 140. However, the present disclosure contemplates that the actuator 160 may be within the housing 144 of the port 140.

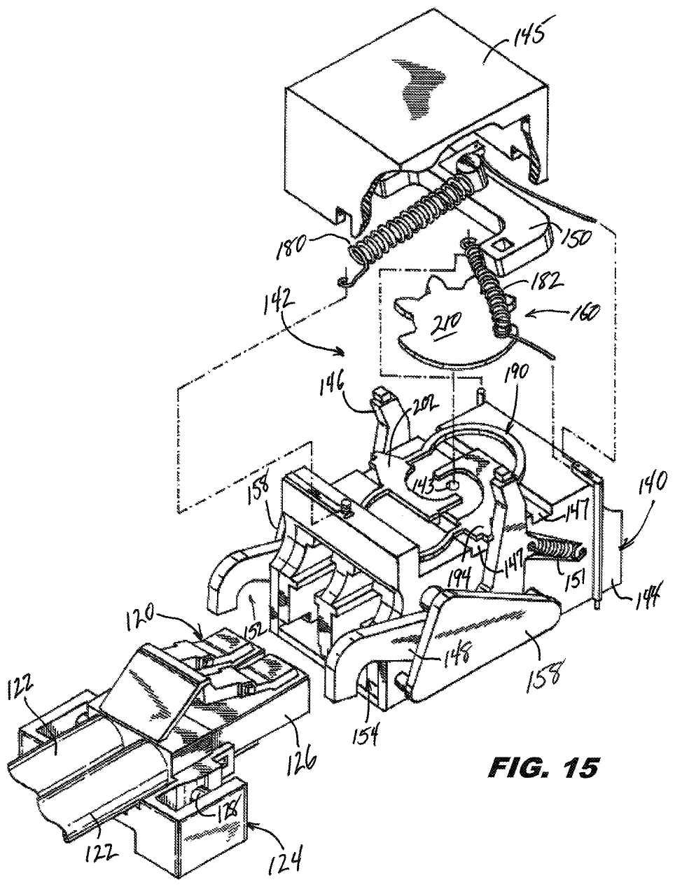

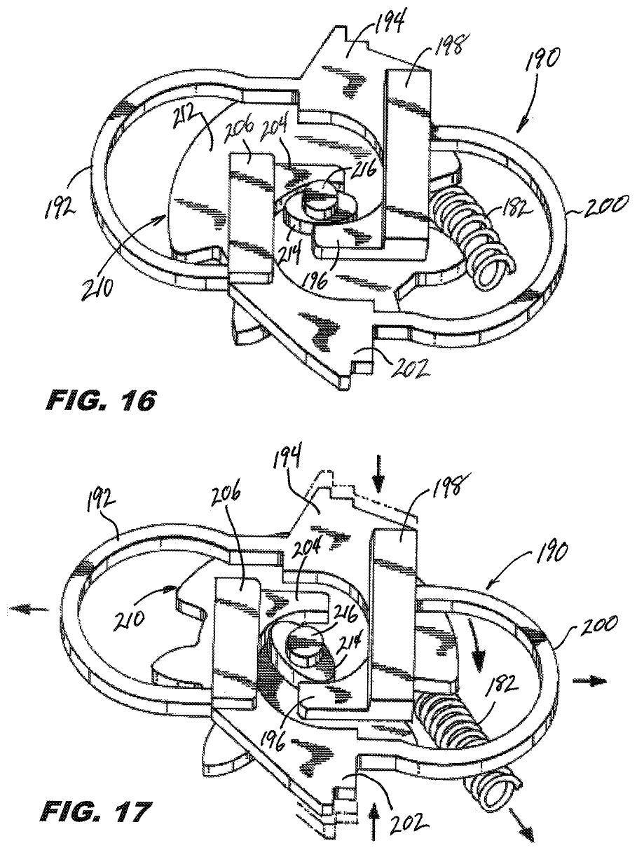

In the exemplary embodiment shown, the first push and/or pull member 180 is a spring made of a material having shape memory properties, such as a shape memory alloy. Non-limiting examples of shape memory alloys include Nitinol, Flexinol® and Muscle Wire. For this exemplary embodiment, the first push and/or pull member will be referred to as the spring 180. The second push and/or pull member 182 is a spring made of a material having shape memory properties, such as a shape memory alloy. Non-limiting examples of shape memory alloys include Nitinol, Flexinol® and Muscle Wire. For this exemplary embodiment, the second push and/or pull member will be referred to as the spring 182. As shown in FIGS. 16 and 17, the arm locking member 190 is a spring-like member having a first portion that includes a first swing arm 192, a first blocker 194, a first blocker drive 196 and a first rail 198. The spring-like member also has a second portion that includes a second swing arm 200, a second blocker 202, a second blocker drive 204 and a second rail 206. The arm locking member 190 is positioned on a top surface 144a of the housing 144 of the port 140 so that the first rail 198 and the second rail 206 are positioned within tracks 147 in the top surface 144a of the housing. The tracks 147 and the rails 198 and 206 guide movement of the arm locking member 190 as described below. The lock release member 210 includes a body 212, a drive member 214 and a mounting pin 216. The drive member 214 is positioned on the body 212 and may be integrally or monolithically formed into the body, or the drive member 214 may be secured to the body 212 using, for example, welds or adhesives. Preferably, the drive member 214 is centrally located on the body 212. The drive member 214 is configured and dimensioned to selectively apply a force on the first blocker drive 196 and the second blocker drive 204 at substantially the same time. Preferably, the drive member 214 is elliptical in shape, as shown in FIG. 16. The mounting pin 216 extends from the drive member 214 and is generally cylindrical in structure. The mounting pin 216 is configured and dimensioned to fit with a mounting aperture 143, seen in FIG. 15, in the top surface 144a of the housing 144 so that the mounting pin 216 is rotatable within the mounting aperture 143. The lock release member 210 is positioned on the arm locking member 190 such that the drive member 214 of the lock release member 210 is between the first blocker drive 196 and the second blocker drive 204, seen in FIG. 16, and the mounting pin 216 is positioned within the mounting aperture 143. In operation, the first swing arm 192 and the second swing arm 200 are initially in an undeflected position, seen in FIG. 16, such that the first blocker 194 and the second blocker 202 are in an extended position. When in the extended position, the first blocker 194 and the second blocker 202 are positioned to block movement of the first locking arm 146 and the second locking arm 148 of the locking assembly 142 such that the first locking arm 146 and the second locking arm 148 are maintained in the locked position. When the drive member 214 of the lock release member 210 is rotated as described below, the drive member 214 applies a force on the first blocker drive 196 and the second blocker drive 204 of the lock release member 210. The force applied by the drive member 214 pushes the first blocker drive 196 and the second blocker drive 204 toward each other and outwardly deflects the first swing arm 192 and the second swing arm 200, as shown in FIG. 17. Pushing the first blocker drive 196 and the second blocker drive 204 toward each other causes the first blocker 194 and the second blocker 202 to move toward a retracted position. With the first blocker 194 and the second blocker 202 in the retracted position, the first locking arm 146 and the second locking arm 148 of the locking assembly 142 are released and free to move.

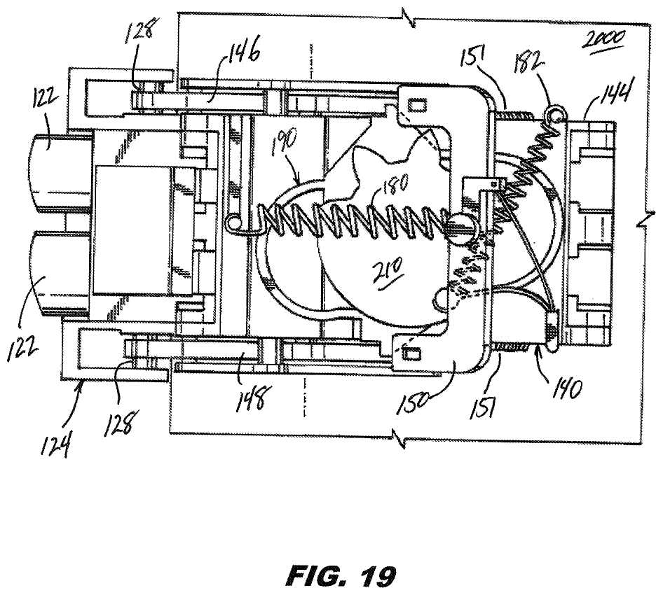

Movement of the first locking arm 146 and the second locking arm 148 of the locking assembly 142 will be described with reference to FIGS. 18-22. As noted, the actuator 160 is electrically and/or operatively connected to the controller 750 so that the controller can apply a signal that activates the actuator 160 to move the locking assembly 142 between the unlocked position and the locked position. In the unlocked position, the drive member 214 of the lock release member 210 is in its normal position, seen in FIG. 16, where the first locking arm 146 and the second locking arm 148 are moved, e.g., pivoted, by springs 151 attached to the housing 144 and locking arms 146 and 148. Moving the locking arms 146 and 148 so that the locking notches 152 and 154 release the locking members 128 of the clip member 124, as shown in FIGS. 18 and 19. In the unlocked position, a connector 120 can be inserted into or removed from the port 140. To move the locking assembly 142 from the unlocked position to the locked position, the spring 180 is temporarily activated by the controller 750, seen in FIG. 53, which compresses the spring 180 and pulls the connecting arm 150 between the first locking arm 146 and the second locking arm 148 in the direction of arrow “G” toward the connector 120. Movement of the connecting arm 150 in the direction of arrow “G” pivots the first locking arm 146 and the second locking arm 148 so that the locking notches 152 and 154 capture the locking members 128 of the clip member 124. The first blocker 194 and second blocker 202 of the arm locking member 190 then holds the first and second locking arms 146 and 148 in the locked position. In the locked position, the connector 120 is prevented from being removed from or inserted into the port 140.

Continuing to refer to FIGS. 18-22, to move the first and second locking arms 146 and 148 from the locked position to the unlocked position, the spring 182 of the actuator 160 is temporarily activated by the controller 750 which compresses the spring 182 and pulls the lock release member 210 of the actuator 160 in the direction of arrow “I” as shown in FIG. 21. Pulling the lock release member 210 in the direction of arrow “I,” rotates the drive member 214, as shown in FIG. 17. As described above, rotating the drive member 214 pushes the first blocker drive 196 and the second blocker drive 204 toward each other and outwardly deflects the first swing arm 192 and the second swing arm 200, as shown in FIG. 17. Pushing the first blocker drive 196 and the second blocker drive 204 toward each other causes the first blocker 194 and the second blocker 202 to move toward a retracted position. With the first blocker 194 and the second blocker 202 in the retracted position, the first locking arm 146 and the second locking arm 148 of the locking assembly 142 are released and free to move. With the first and second locking arms 146 and 148 free to move, the springs 151 of the actuator 160 automatically moves, e.g., pivots, the first and second locking arms 146 and 148 to the unlocked position. The controller 750 then deactivates the spring 182 permitting the spring to cool. As the spring 182 cools, the spring 182 expands causing the drive member 214 to rotate in an opposite direction back to its normal position, seen in FIG. 16.

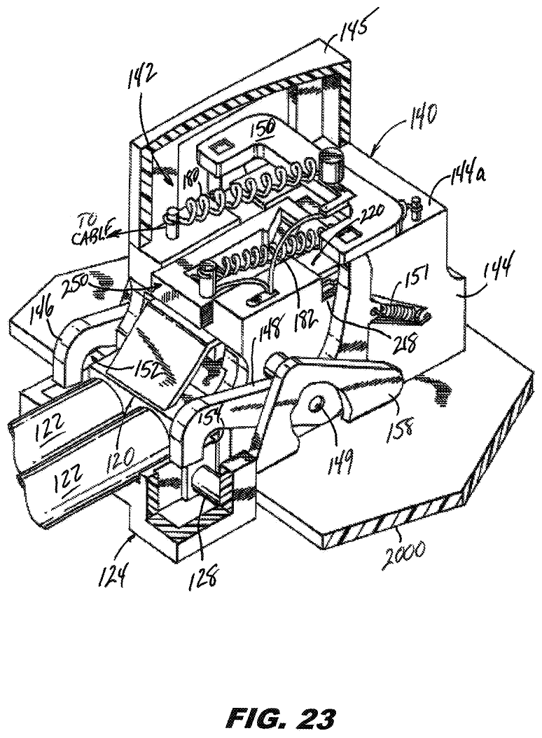

Referring now to FIGS. 23-29, another exemplary embodiment of the fiber mating assembly 100 is shown. The fiber mating assembly 100 is substantially the same as the fiber mating assembly 100 described above such that like reference numbers are used for like elements. Except in this exemplary embodiment, the arm locking member and the lock release member of the actuator 160 differ. In this exemplary embodiment, the actuator 160 is an assembly of two or more components that includes the first push and/or pull member 180, the second push and/or pull member 182, an arm locking member 220 and lock release member 250. At least a portion of the locking assembly 142 and the actuator 160 are mounted to an exterior surface of the housing 144 of the port 140. However, the present disclosure contemplates that the actuator 160 may be within the housing 144 of the port 140. In this embodiment, the arm locking member 220 and the lock release member 250 use linear motion instead of the rotational motion described above to hold the first and second locking arms 146 and 148 in the locked position.

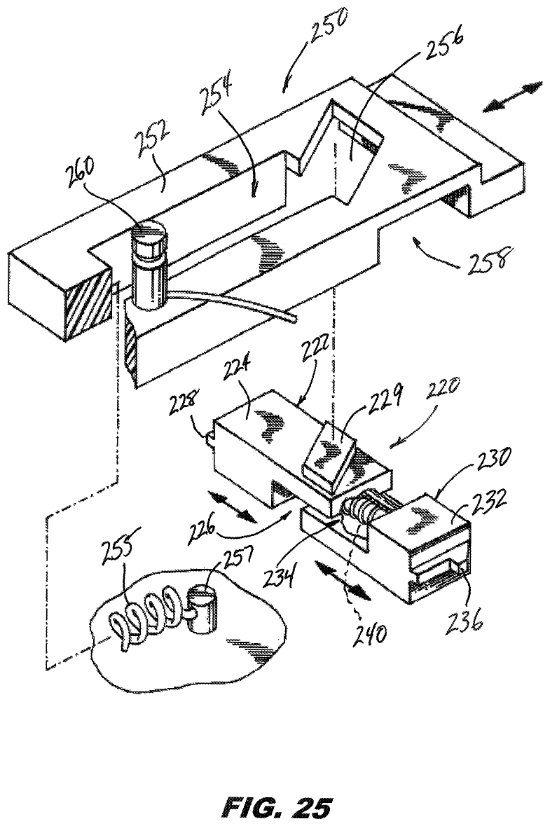

In this embodiment, the arm locking member 220 is a two piece assembly that includes slide arm or rail 222 and slide arm or rail 230. The slide arm 222 includes a body 224 having a notch 226 at one end and a first blocker 228 at the other end. The body 224 also includes a rib 229 that extends away from the body 224, as shown in FIG. 25. The rib 229 is configured and dimensioned to fit within a locking opening 256 in a body 252 of the lock release member 250 described below. The rib 229 is provided to lock the lock release member 250 in an extended position. The slide arm 230 includes a body 232 having a notch 234 at one end and a second blocker 236 at the other end. In the embodiment shown, the slide arms 222 and 230 are coupled so that they at least partially overlap at the notches 226 and 234 and are linearly movable relative to each other. The slide arms 222 and 230 may be normally biased outwardly, e.g., pushed away from each other, by a biasing member 240, seen in FIG. 25, that is installed between the two slide arms 222 and 230. The biasing member 240 may also be used to couple the slide arms or rails 222 and 230 to each other. The slide arms 222 and 230 of the arm locking member 220 slide within a track 218 on the top surface 144a of the housing 144 of the port 140 between an extended position and a retracted position. When in the extended position, the first blocker 228 and the second blocker 236 are positioned to block movement of the first locking arm 146 and the second locking arm 148 of the locking assembly 142 such that the first locking arm 146 and the second locking arm 148 are maintained in the locked position. When in the retracted position, the first blocker 228 and the second blocker 236 are positioned so that they do not block movement of the first locking arm 146 and the second locking arm 148 of the locking assembly 142 such that the first locking arm 146 and the second locking arm 148 are released and free to move.

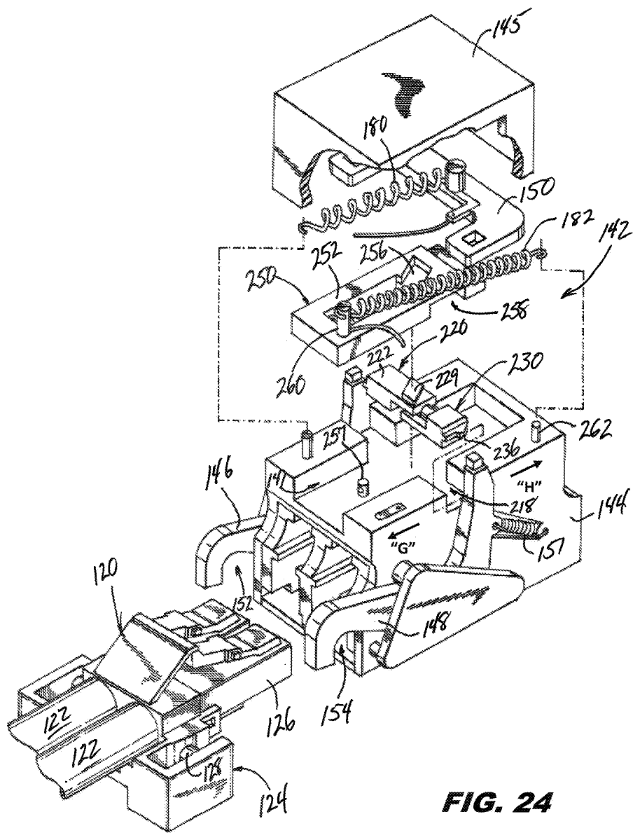

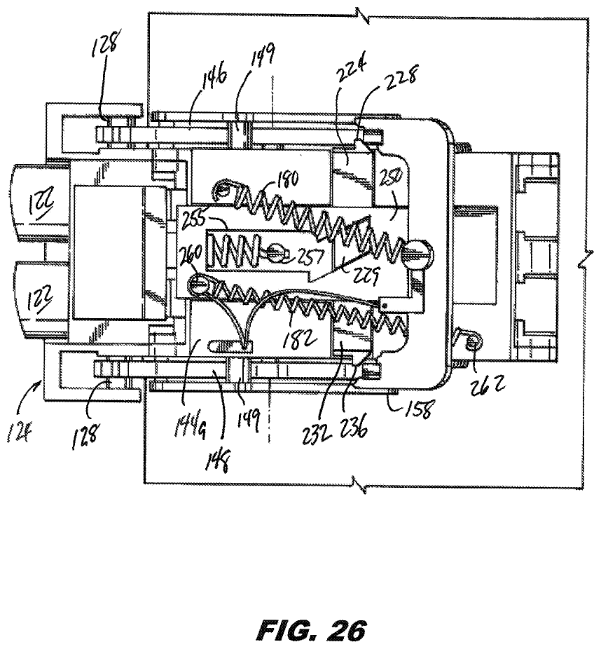

The lock release member 250 includes a body 252 having a channel 254, a locking opening 256 and a track 258. The body 252 is configured and dimensioned to fit within a track 141 in the top surface 144a of the housing 144 so that the body 252 is slidable within the track 141. The lock release member 250 also includes a biasing member 255, such as the spring shown in FIG. 26, having a first end secured to or otherwise engaging an interior wall of the channel 254 and a second end secured to a mounting post 257 extending from the top surface 144a of the housing 144 into the channel 254, as shown in FIG. 26. The biasing member 255 normally biases the body 252 in the direction of arrow “G” shown in FIG. 24. Moving or pushing the body 252 within the track 141 in the direction of arrow “G” cause the rib 229 to move in the locking opening 256 so that the slide arms 222 and 230 of the arm locking member 220 are moved away from each other into the extended position. As mentioned above, when the slide arms 222 and 230 of the arm locking member 220 are in the extended position, the first blocker 228 and the second blocker 236 are positioned to block movement of the first locking arm 146 and the second locking arm 148 of the locking assembly 142 such that the first locking arm 146 and the second locking arm 148 are maintained in the locked position. In this embodiment, the spring 182 has a first end attached to a mounting post 260 secured to and extending from the body 252 and a second end attached to a mounting post 262 secured to and extending from the top surface 144a of the housing 144. When activated, the spring 182 moves the body 252 of the arm locking member 220 in the direction of arrow “H” shown in FIG. 24.

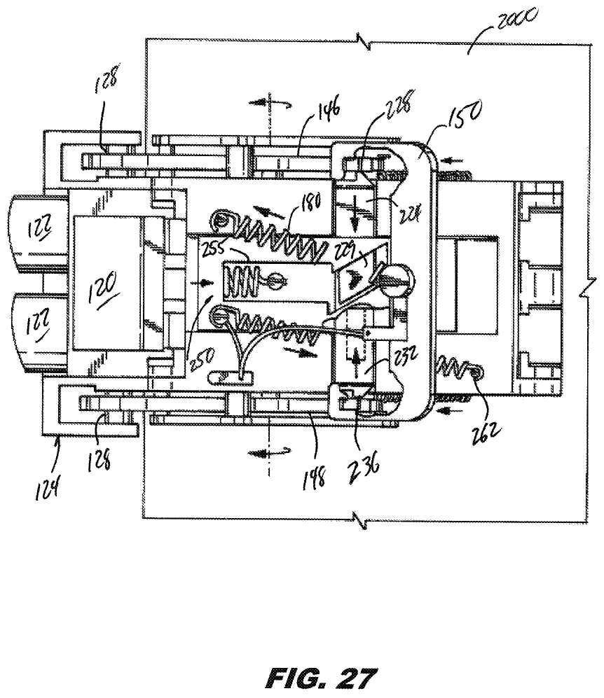

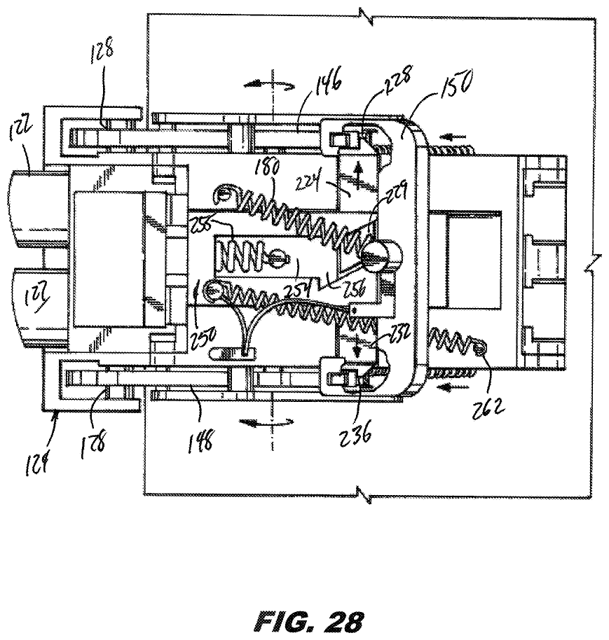

Movement of the first locking arm 146 and the second locking arm 148 of the locking assembly 142 will be described with reference to FIGS. 26-29. As noted, the actuator 160 is electrically and/or operatively connected to the controller 750 so that the controller can apply a signal that activates the actuator 160 to move the locking assembly 142 between the unlocked position and the locked position. In FIG. 26, the slide arms 222 and 230 of the arm locking member 220 are in the extended position and the first and second locking arms 146 and 148 are in the unlocked position permitting a connector 120 to be inserted into or removed from the port 140. To move the locking assembly 142 from the unlocked position to the locked position, the spring 180 is temporarily activated by the controller 750, which compresses the spring 180, seen in FIG. 27, and pulls the connecting arm 150 in the direction of arrow “G” toward the connector 120. Movement of the connecting arm 150 in the direction of arrow “G” moves, e.g., pivots, the first locking arm 146 and the second locking arm 148 so that the locking notches 152 and 154 capture the locking members 128 of the clip member 124. As the first and second locking arms 146 and 148 begin to move, the locking arms 146 and 148 ride along a tapered wall of the first and second blockers 228 and 236 of the slide arms 222 and 230 moving the slide arms 222 and 230 toward each other and moving the lock release member 250 in the direction of arrow “H” and compressing the spring 182 and spring 255, as shown in FIG. 27. When the first and second locking arms 146 and 148 past the first and second blockers 228 and 236, the spring 255 biases the lock release member 250 back to its normal position causing the rib 229 in the locking opening 256 of the lock release member 250 to move the slide arms 222 and 230 back to the extended position. At this point, the first and second blockers 228 and 236 are positioned behind the first and second locking arms 146 and 148 blocking movement of the first and second locking arms 146 and 148 as shown in FIG. 28. As a result, the first and second locking arms 146 and 148 are locked in the locked position. In the locked position, the connector 120 is prevented from being removed from or inserted into the port 140.

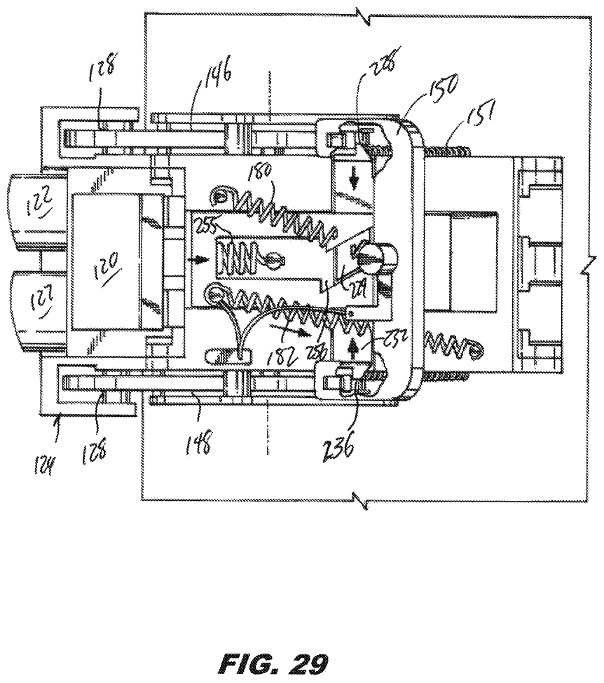

Continuing to refer to FIG. 29, to move the first and second locking arms 146 and 148 from the locked position to the unlocked position, the spring 182 of the actuator 160 is temporarily activated by the controller 750 which compresses the spring 182 and pulls the lock release member 250 of the actuator 160 in the direction of arrow “H”. Pulling the lock release member 250 in the direction of arrow “H” causes the rib 229 to slide within the locking opening 256 so that the slide arms 222 and 230 of the arm locking member 220 are moved toward each other into the retracted position. When in the retracted position, the first blocker 228 and the second blocker 236 are positioned so that they do not block movement of the first locking arm 146 and the second locking arm 148 of the locking assembly 142 such that the first locking arm 146 and the second locking arm 148 are released and free to move. With the first and second locking arms 146 and 148 free to move, the springs 151 pull the first and second locking arms 146 and 148 in the direction of arrow “H” until the first and second locking arms 146 and 148 are in the unlocked position. As mentioned, when the first and second locking arms 146 and 148 are in the unlocked position, permitting a connector 120 to be inserted into or removed from the port 140.

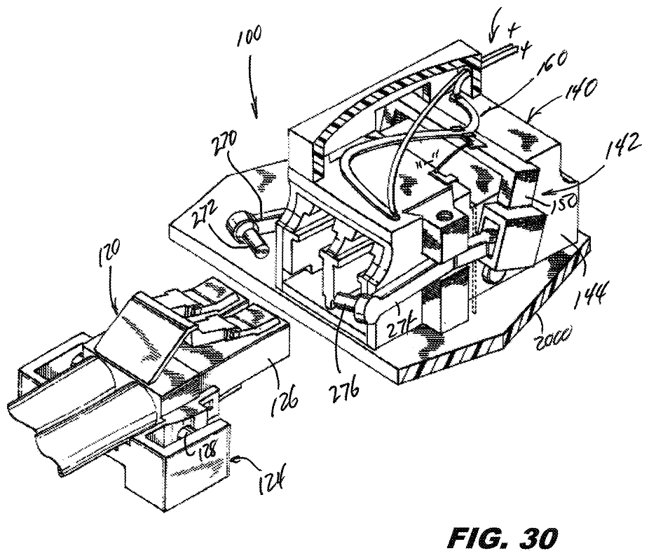

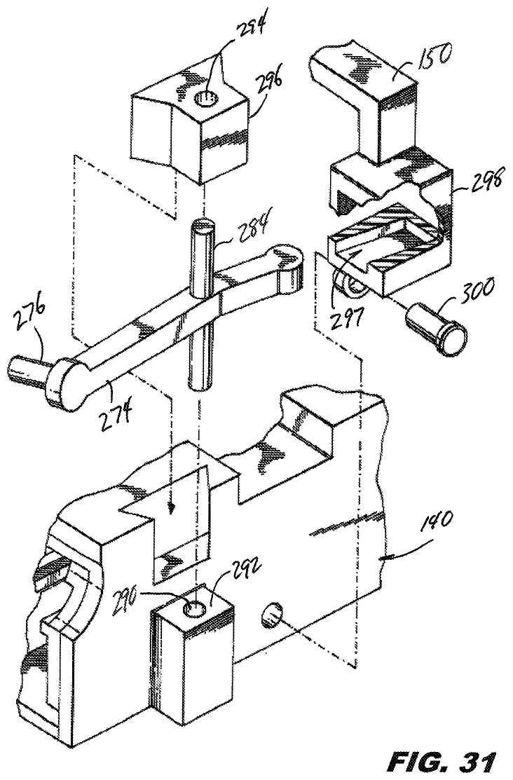

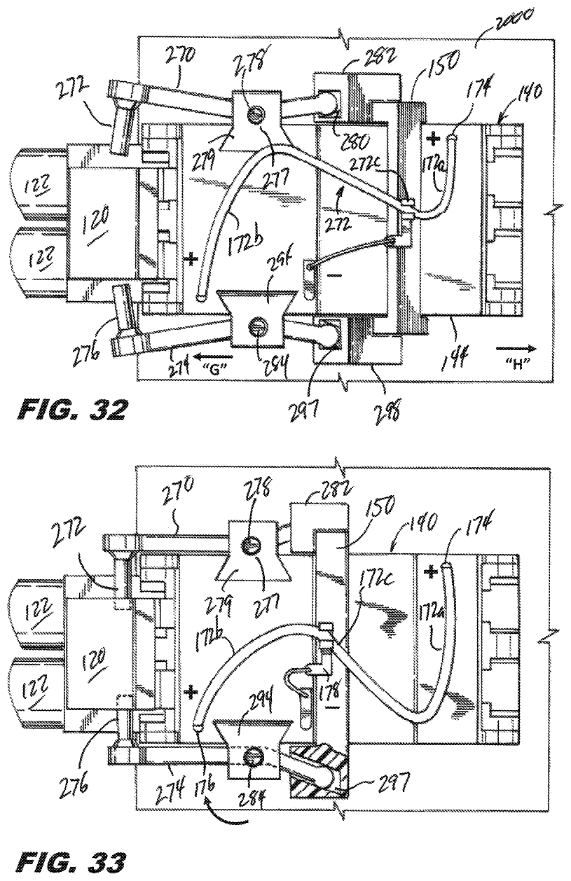

Referring now to FIGS. 30-33, another exemplary embodiment of the fiber mating assembly is shown. In this exemplary embodiment, the fiber mating assembly 100 is substantially the same as the fiber mating assembly 100 described above such that like reference numbers are used for like elements, except the first and second locking arms of the locking assembly 142 differ. In this exemplary embodiment, the locking arm 270 includes a blocking member 272 and the locking arm 274 includes a blocking member 276. The blocking members 272 and 276 are used slide under and engage the alligator clip 121 of the connector 120 to lock the connector 120 to the port 140 by blocking the connector 120 from being removed from the port 140. In the exemplary embodiment shown, the blocking members 272 and 276 are pins. The locking arm 270 is an elongated member having the locking member 272 extending from the first end of the locking arm 270 so that the locking member 272 is substantially perpendicular to a longitudinal axis of the locking arm 270. At a point along the length of the locking arm 270 is a pivot pin 278 extending therethrough. The pivot pin 278 has a first end positioned within a mounting aperture (not shown) in a mounting block (not shown) extending from the housing 144 of the port 140 that is similar to mounting aperture 290 and mounting block 292 described below. The second end of the pivot pin 278 is positioned within an aperture 277 in mounting block 279. The mounting block 279 is secured to the housing 144 using, for example, a dove tail joint as shown in FIG. 32. However, the mounting block 279 may be secured to the housing 144 using welds, adhesives and mechanical fasteners. From a point on the locking arm 270 after the pivot pin 278 the locking arm 270 is angled so that a second end of the locking arm 270 is offset from the longitudinal axis of the locking arm 270. The second end of the locking arm 270 includes a boss that is configured and dimensioned to fit within an opening 280 in hub 282. The hub 282 is attached to the first end of the connecting arm 150. The hub 282 is attached to the housing 144 with a pivot pin 287 so that the hub 298 can pivot as the locking arm moves. Similarly, the locking arm 274 is an elongated member having the locking member 276 extending from a first end of the locking arm 274 so that the locking member 276 is substantially perpendicular to a longitudinal axis of the locking arm 270. At a point along the length of the locking arm 270 is a pivot pin 284 extending therethrough. The pivot pin 284 has a first end positioned within a mounting aperture 290 in a mounting block 292 extending from the housing 144 of the port 140. A second end of the pivot pin 284 is positioned within an aperture 294 in mounting block 296. The mounting block 296 is secured to the housing 144 using, for example, a dove tail joint as shown in FIG. 31. However, the mounting block 296 may be secured to the housing 144 using welds, adhesives and mechanical fasteners. From a point on the locking arm 274 after the pivot pin 284 the locking arm 274 is angled so that a second end of the locking arm 274 is offset from the longitudinal axis of the locking arm. The second end of the locking arm 274 includes a boss that is configured and dimensioned to fit within an opening 297 in hub 298. The hub 298 is attached to the second end of the connecting arm 150. The hub 298 is attached to the housing 144 with a pivot pin 300 so that the hub 298 can pivot as the locking arm moves.

In this exemplary embodiment, the actuator 160 is the push and/or pull member 172 described above. In operation, when the controller 750 activates, e.g., applies a current to, the first portion 172a of the spring 172, the first portion 172a of the spring 172 pulls the connecting arm 150 in the direction of arrow “H” so that the hubs 282 and 298 pivot causing the first locking arm 270 and the second locking arm 274 of the locking assembly 142 to the unlock position, as shown in FIG. 32. In the unlocked position, the locking member 272 and the locking member 276 are positioned, e.g., pivoted, outside of the alligator clip 121 of the connector 120. With the locking members 272 and 276 outside the alligator clip 121, the connector 120 is not prevented from being removed from or inserted into the port 140. Further, when the controller 750 activates, e.g., applies a current to, the second portion 172b of the spring 172, the second portion 172b of the spring 172 pulls the connecting arm 150 in the direction of arrow “G” so that the boss of the first and second locking arms 270 and 274 slide within the angled openings 280 and 297 in the hubs 282 and 298 to move, e.g., pivot, the first locking arm 270 and the second locking arm 274 of the locking assembly 142 to the locked position, shown in FIG. 33.

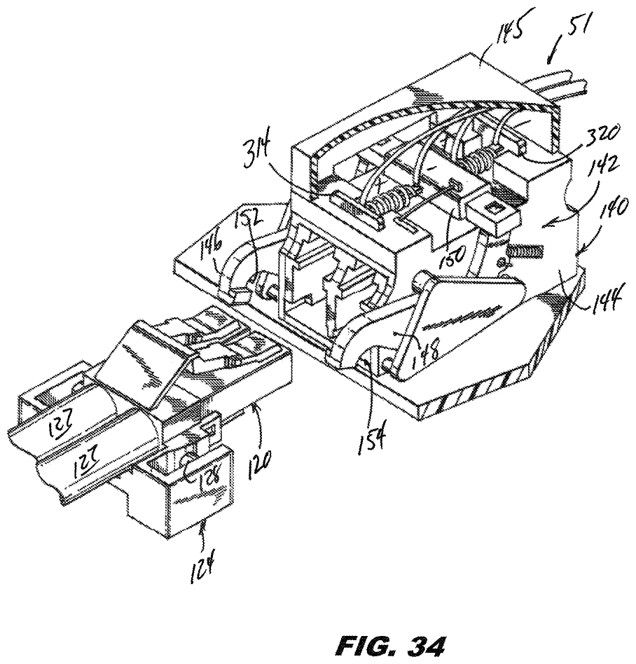

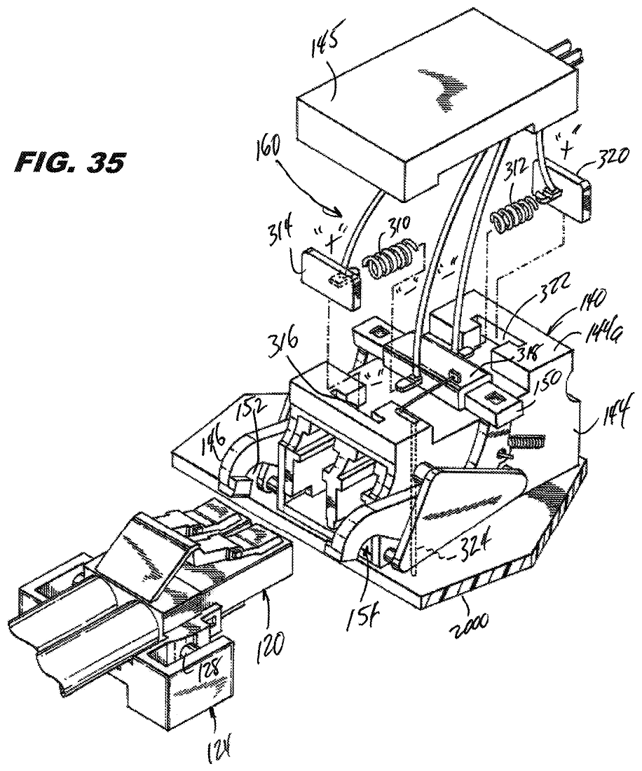

Referring to FIGS. 34-37, another exemplary embodiment of the fiber mating assembly is shown. In this exemplary embodiment, the fiber mating assembly 100 is substantially the same as the fiber mating assembly 100 described above such that like reference numbers are used for like elements, except the actuator 160 differs. In this exemplary embodiment, the actuator 160 includes a first push and/or pull member 310 and a second push and/or pull member 312. The first push and/or pull member 310 is a spring made of a material having shape memory properties, such as a shape memory alloy. Non-limiting examples of shape memory alloys include Nitinol, Flexinol® and Muscle Wire. The first push and/or pull member 310 may also be a solenoid. For this exemplary embodiment, the push and/or pull member will be referred to as the spring 310. The spring 310 has one end connected to an electrical terminal 314 that is secured within a slot 316 in the top surface 144a of the housing 144. The other end of the spring 310 is connected to a common electrical terminal 318 that is positioned on the connecting arm 150. The second push and/or pull member 312 is a spring made of a material having shape memory properties, such as a shape memory alloy. Non-limiting examples of shape memory alloys include Nitinol, Flexinol® and Muscle Wire. The second push and/or pull member 312 may also be a solenoid. For this exemplary embodiment, the push and/or pull member will be referred to as the spring 312. The spring 312 has one end connected to an electrical terminal 320 that is secured within a slot 322 in the top surface 144a of the housing 144. The other end of the spring 312 is connected to the common electrical terminal 318 that is positioned on the connecting arm 150. The common electrical terminal 318 is connected via a conductive path 324 to the cable 51, and the electrical terminals 314 and 320 are connected to the cable 51. In operation,

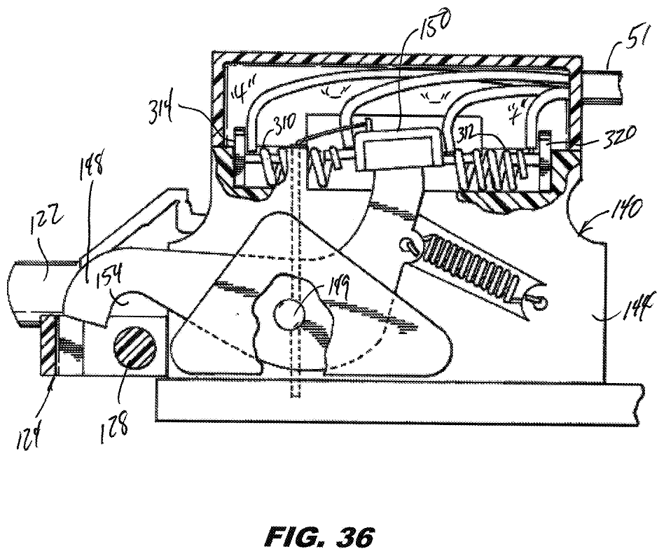

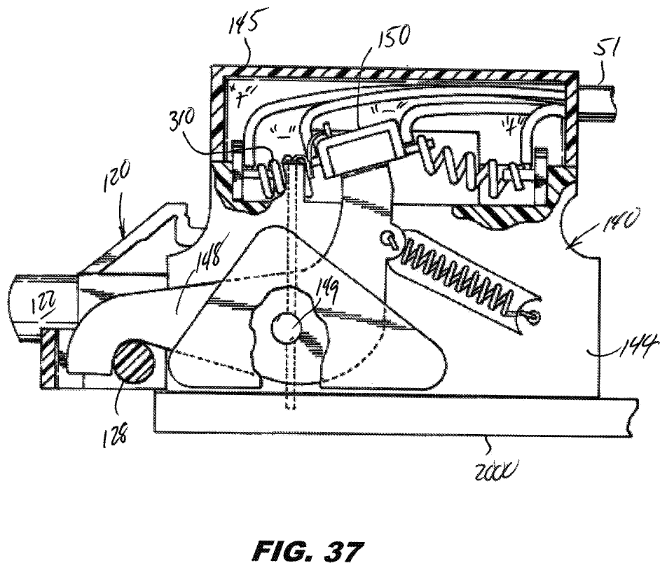

Movement of the first locking arm 146 and the second locking arm 148 of the locking assembly 142 will be described with reference to FIGS. 36 and 37. As noted, the actuator 160 is electrically and/or operatively connected to the controller 750 so that the controller can apply a signal, e.g., a current, via cable 51 to activate the actuator 160 to move the locking assembly 142 between the unlocked position and the locked position. In FIG. 36, to move the locking assembly 142 and thus the fiber mating assembly 100 to the unlocked position, the controller 750 applies a signal, e.g., a current, to activate the spring 312. Activating the spring 312 heats the spring causing the spring to compress. Compressing the spring 312 applies a pulling force on the connecting arm 150 in the direction of arrow “H.” Movement of the connecting arm 150 in the direction of arrow “H” moves, e.g., pivots the locking arms 146 and 148 to the unlocked position. In the unlocked position, the first locking arm 146 and the second locking arm 148 are pivoted so that the locking notches 152 and 154 release the locking members 128 of the clip member 124. With the locking assembly 142, and thus the fiber mating assembly 100, in the unlocked position, the connector 120 can be removed from the port 140 or inserted into the port 40. With the connector 120 removed from the port 140, the controller 750 can remove the signal, e.g., remove the current, activating the spring 312 so that the spring 312 cools. As the spring 312 cools, the pulling force applied by the spring 312 on the connecting arm 150 reduces. In instances where a biasing member 151, e.g., a spring, is used, the biasing member 151 would maintain the connecting arm 150 and the locking arms 146 and 148 in the unlocked position. In instances where the biasing member 151 is not used, there would be no or limited force on the connecting arm 150 thus maintaining the locking arms 146 and 148 in the unlocked position.

In FIG. 37, to move the locking assembly 142 and thus the fiber mating assembly 100 to the locked position, the controller 750 applies a signal, e.g., a current, to activate the spring 310. Activating the spring 310 heats the spring causing the spring to compress. Compressing the spring 310 applies a pulling force on the connecting arm 150 in the direction of arrow “G.” This pulling force on the connecting arm 150 moves, e.g., pivots, the locking arms 146 and 148 to the locked position where the locking notches 152 and 154 can receive the locking members 128 of the clip member 124 of the connector 120. It is noted that as the biasing member 168 applies pulling force on the central mounting post 164, the spring 162 expands, as shown in FIG. 12. When the locking members 128 are captured within the locking notch 152 of the locking arm 146 and the locking notch 154 of the locking arm 148, the locking assembly 142, and thus the fiber mating assembly 100, is in the locked position. With the fiber mating assembly 100 in the locked position, the connector 120 is prevented from being removed from or inserted into the port 140.

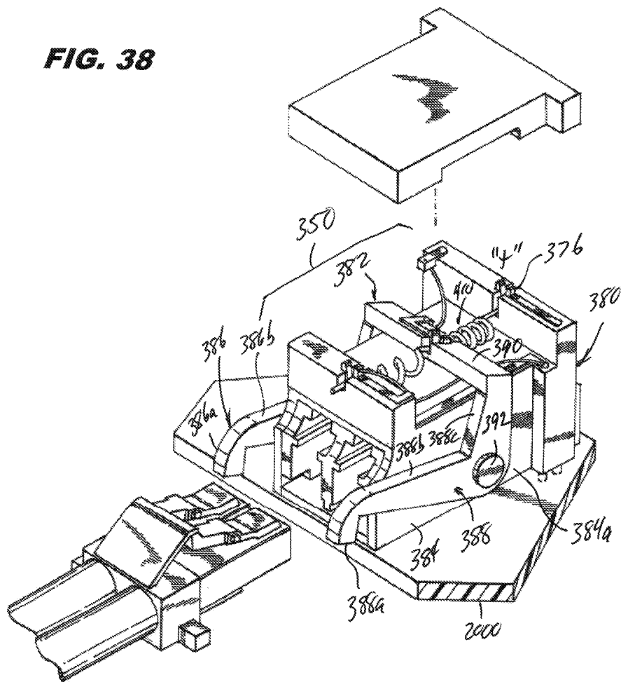

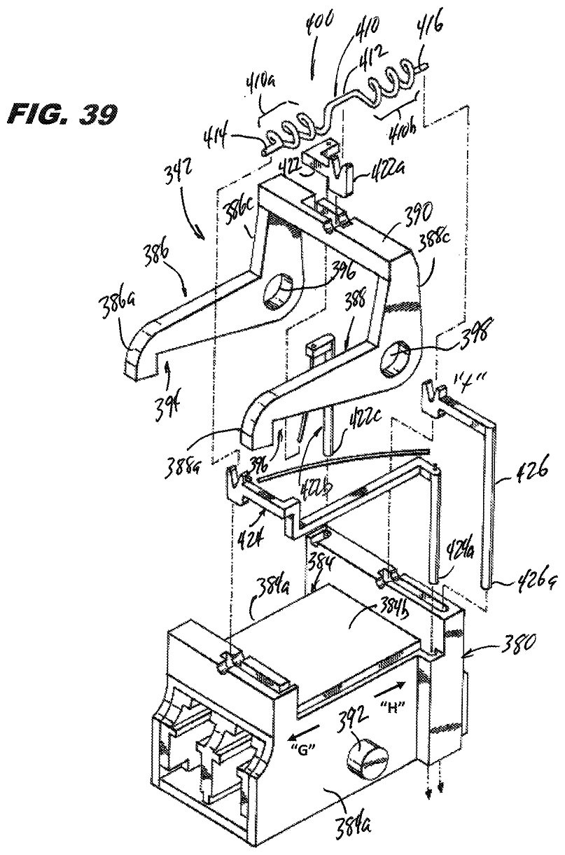

Referring to FIGS. 38-42, another exemplary embodiment of a fiber mating assembly 350 is shown. In this embodiment, the fiber mating assembly 350 includes a paired single fiber connector 360 and a paired single fiber port 380. Referring to FIGS. 38 and 39, the single fiber connector 360 is similar to known LC connectors that can be operatively connected to single fiber cables 362, except the connector 360 includes a clip member 364. The clip member 364 may be integrally or monolithically formed into a housing 366 of the connector 360, or the clip member 364 may be releasably or permanently secured to the housing 366 of the connector 360. The clip member 364 includes one or more locking members 368 that are configured and dimensioned to be captured by a locking assembly 382 of the port 380 as described below.

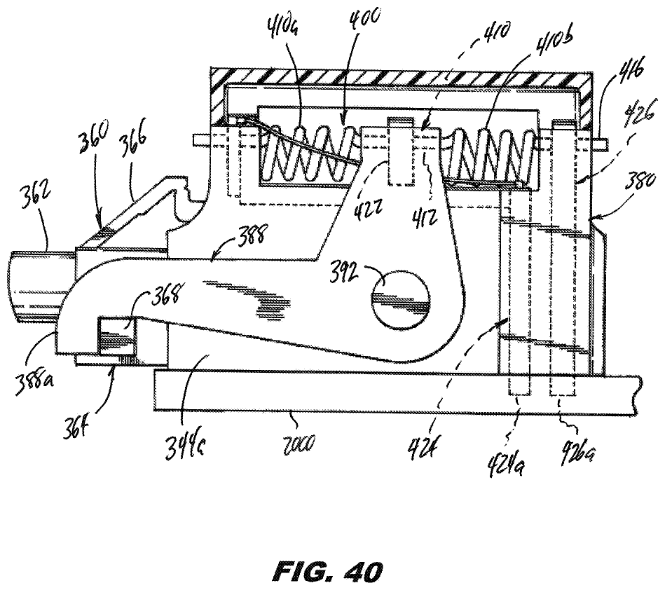

Referring to FIGS. 38-42, the port 380 is similar to known LC ports that can be operatively connected to a single fiber connector 360, except the port 380 includes a locking assembly 382 that may be integrally or monolithically formed into a housing 384 of the port 380, or the locking assembly 382 may be releasably or permanently secured to the housing 384 of the port 380. The port 380 may be mounted to a platform similar to platform 2000 described above. Non-limiting examples of a platform include printed circuit boards and surfaces of a housing or brackets within a housing of components within a datacenter. The locking assembly 382 includes a first locking arm 386, a second locking arm 388 and a connecting arm 390 between the first locking arm 386 and the second locking arm 388. The first locking arm 386 is pivotably secured to the housing 384 of the port 380 using pin 392 extending from side walls 384a of the housing 384. The first locking arm 386 has a locking bar 386a that extends from the first end of a main bar 386b. The locking bar 386a is at an angle, preferably, about 90 degrees, relative to the main bar 386b to form a space 394 configured to receive the one or more locking members 368 of the clip member 364, seen in FIGS. 40-43. When in a locking position, the locking bar 386a blocks the one or more locking members 368 of the clip member 364 from moving so that the connector 360 cannot be removed from the port 380. Extending from the second end of the main bar 386b is a riser 386c. The riser 386c is at an angle, preferably about 90 degrees, relative to the main bar 386b. The riser 386c is used couple the locking arm 386 to the connecting arm 390. To movably mate the locking arm 386 to the port 380, the locking arm 386 includes a pin aperture 396 configured to receive a pin 392 extending from side walls 384a of the housing 384 of the port 380. Similarly, the second locking arm 388 is pivotably secured to the housing 384 of the port 380 using pin 392 extending from side walls 384a of the housing 384. The second locking arm 388 has a locking bar 388a that extends from the first end of a main bar 388b. The locking bar 388a is at an angle, preferably about 90 degrees, relative to the main bar 388b to form a space 396 configured to receive the one or more locking members 368 of the clip member 364, seen in FIGS. 38 and 39. When in a locking position, the locking bar 388a blocks the one or more locking members 368 of the clip member 364 from moving so that the connector 360 cannot be removed from the port 380. Extending from the second end of the main bar 388b is a riser 388c. The riser 388c is at an angle, preferably about 90 degrees, relative to the main bar 388b. The riser 388c is used couple the locking arm 388 to the connecting arm 390. To movably mate the locking arm 388 to the port 380, the locking arm 388 includes a pin aperture 398 configured to receive a pin 392 extending from side walls 384a of the housing 384 of the port 380. It is noted that the locking spaces 394 and 396 are configured to receive the locking members 368 of the clip member 364 of the connector 360 so that the locking members 368 are captured within the locking spaces 394 and 396 such that the fiber mating assembly 350 is in a locked position where the connector 360 is prevented from being removed from the port 380.

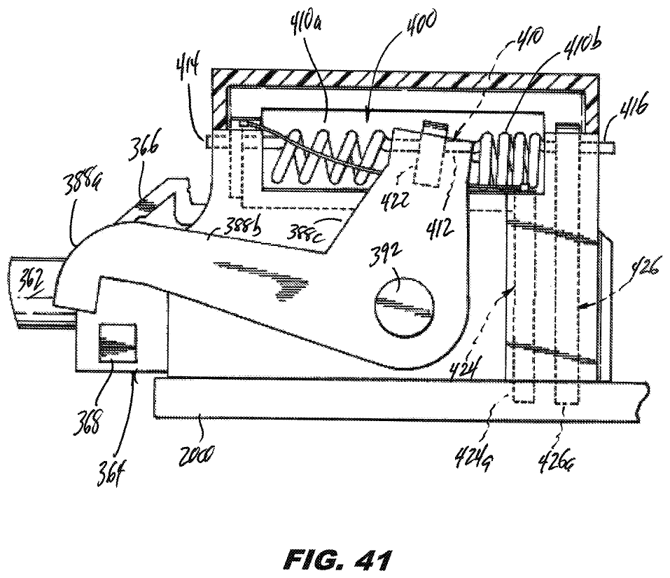

Continuing to refer to FIG. 39, the locking assembly 382 of the fiber mating assembly 350 is an electronically controlled member where a controller 750, seen in FIG. 53, either internal or external to a housing of components within a datacenter, controls the operation of the locking assembly 382. More specifically, an actuator 400 is used to move the locking assembly 382 between an unlocked position, seen in FIG. 41, and a locked position, seen in FIG. 40. The actuator 400 may be an assembly of two or more components or the actuator 400 may be a single member. In this exemplary embodiment, the actuator 400 is a single member. The actuator 400 is mounted to a top exterior surface 384b of the housing 384 of the port 380. However, the present disclosure contemplates that the actuator 400 may be within the housing 384 of the port 380. The actuator 400 is electrically and/or operatively connected to the controller 750 so that the controller can apply a signal, e.g., a current, that activates the actuator 400 to move the locking assembly 382 between the locked position and the unlocked position. In the unlocked position, the first locking arm 386 and the second locking arm 388 are moved, e.g., pivoted, by the actuator 400 so that the locking spaces 394 and 396 release the locking members 368 of the clip member 324. In the unlocked position, the connector 360 can be inserted into or removed from the port 380. In the locked position, the first locking arm 386 and the second locking arm 388 are moved, e.g., pivoted, by the actuator 400 so that the locking spaces 394 and 396 capture the locking members 368 of the clip member 364. In the locked position, the connector 360 is prevented from being removed from or inserted into the port 380.

In the exemplary embodiment shown, the actuator 400 is a single component or member, namely push and/or pull member 410. The push and/or pull member 410 may be a spring. For this exemplary embodiment, the push and/or pull member will be referred to as the spring 410. The spring 410 may be made of a material having shape memory properties, such as a shape memory alloy and solenoids. Non-limiting examples of a shape memory alloys include Nitinol, Flexinol® and Muscle Wire. The spring 410 is preferably a two-way shape-memory alloy having two portions 410a and 410b. As shown in FIGS. 40 and 41, to move the locking assembly 382 from the unlocked position to the locked position, the first portion 410a of the spring 410 is activated by the controller 750 via a cable similar to cable 51. Activating the first portion 410a of the spring 410 heats the first portion 410a which compresses the first portion 410a pulling the connecting arm 390 of the locking assembly 382 in the direction of arrow “G” toward the connector 360. The pulling force of the connecting arm 390 moves, e.g., pivots, the first locking arm 386 and the second locking arm 388 so that the locking spaces 394 and 396 capture the locking members 368 of the clip member 364. In the locking position, the locking bar 386a of the first locking arm 386 and the locking bar 388a of the second locking arm 388 block the one or more locking members 368 of the clip member 364 from moving so that the connector 360 cannot be removed from the port 380 or inserted into the port 380. The locking bars 386a and 388a of the locking arms 386 and 388, respectively, remain in the locked position.

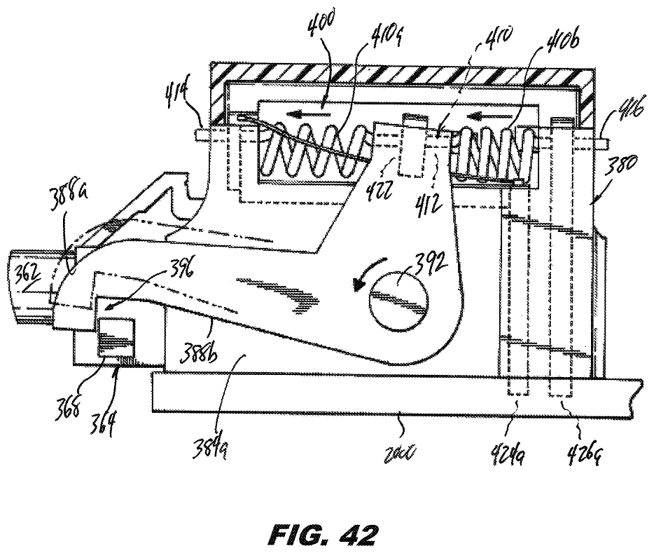

Referring to FIGS. 41 and 42, to move the locking assembly 382 from the unlocked position to the locked position, the second portion 410b of the spring 410 is activated by the controller 750 via a cable similar to cable 51. Activating the second portion 410b of the spring 410 heats the second portion 410b which compresses the second portion 410b pulling the connecting arm 390 of the locking assembly 382 in the direction of arrow “H” away from the connector 360. The pulling force the connecting arm 390 moves, e.g., pivots, the first locking arm 386 and the second locking arm 388 so that the locking bar 386a of the first locking arm 386 and the locking bar 388a of the second locking arm 388 no longer block the locking members 368 of the clip member 364. With the locking bars 386a and 388a no longer blocking the one or more locking members 368 of the clip member 364, the connector 360 is free to be removed from the port 380 or inserted into the port 380. The locking bars 386a and 388a of the locking arms 386 and 388, respectively, of the locking assembly 382 remain in the unlocked position.

Referring to FIG. 39, a contact assembly 420 is provided to energize the spring 410. The contact assembly 420 includes a common contact 422, a first contact 424 and a second contact 426. The common contact 422 is electrically connected to a center portion 412 of the spring 410. The first contact 424 is electrically connected to a first end portion 414 of the spring 410. The second contact 426 is electrically connected to a second end portion 416 of the spring 410. To activate the first portion 410a of the spring 410, the controller 750 completes a circuit between an end 422c of the common contact 422 and the end 424a of the first contact 424. To activate the second portion 410b of the spring 410, the controller 750 completes a circuit between an end 422c of the common contact 422 and the end 426a of the second contact 426. The contacts 422, 424 and 426 are electrically connected to the controller 750.

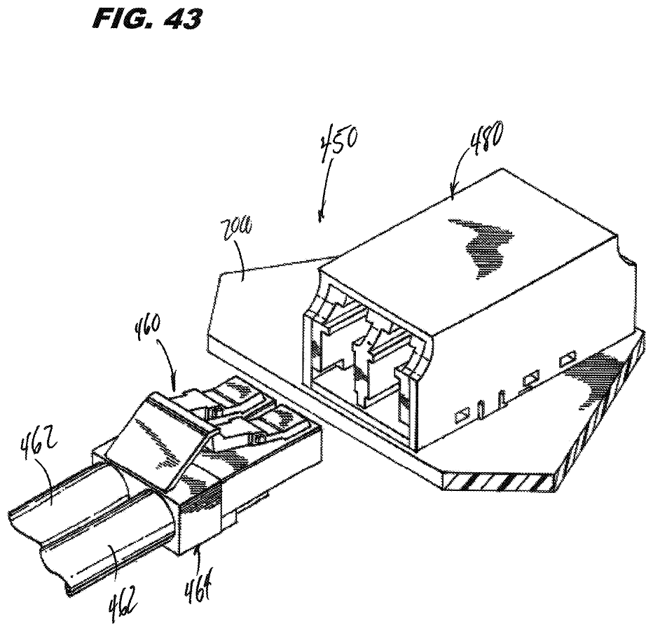

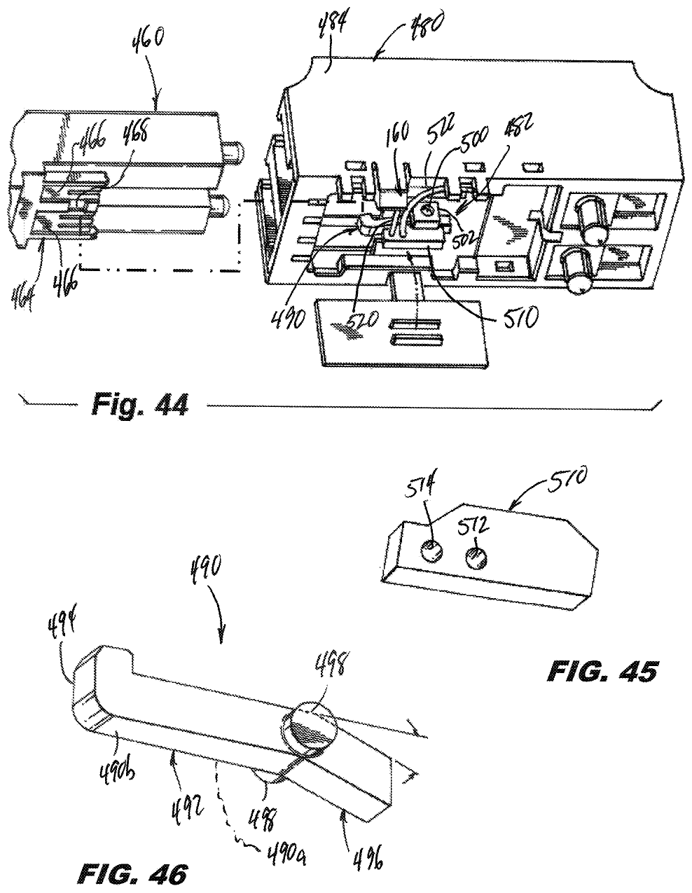

Referring to FIGS. 43-48, another exemplary embodiment of a fiber mating assembly 450 is shown. The fiber mating assembly 450 may include a paired single fiber connector 460, seen in FIG. 43, and a paired single fiber port 480. The paired single fiber connector 460 may also be referred to herein as the “connector 460.” The paired single fiber port 480 may also be referred to herein as the “port 480.” Each connector 460 of the paired fiber connectors is similar to, for example, known LC connectors that can be operatively connected to single fiber cables 462. The connector 460 may include a media interface housing 464 that is configured to receive one or more storage media 466, seen in FIG. 44. In this exemplary embodiment, the one or more storage media 466 are electrical type storage media. Non-limiting examples of electrical type storage media include EEPROM's or other memory chips that can store information, or that can be programmed to store such information. It is noted, the clip members described herein, e.g., clip member 364, may also include one or more storage media, such as storage media 466. The information stored on the storage media 466 includes, for example, identifying data and cable characteristics. Non-limiting examples of the connector identifying data and cable characteristics include connector ID, connector type, cable color, cable length, cable ID, cable fiber type, and any other desired information. A more detailed description of the media interface housing 464 is shown and described in commonly owned U.S. Pat. No. 11,650,380, which is incorporated herein in its entirety by reference. The media interface housing 464 also includes a locking notch 468, which in this example is between two storage media 466. The locking notch 468 is used when locking the connector 460 to the port 440, as described in more detail below.

It is noted that the fiber mating assembly 450 and the other fiber mating assemblies described herein may include a multi-fiber connector and a multi-fiber port instead of single fiber connectors and ports. When using multi-fiber connectors and ports, the multi-fiber connector may be, for example, known MPO connectors and ports, where the multi-fiber connector can be operatively connected to a multi-fiber cable. When using multi-fiber connectors and ports, the multi-fiber connector may use a sleeve positioned over the multi-fiber cable connector and attached to the multi-fiber cable connector. The sleeve may include a media interface housing that is configured to receive one or more storage media, similar to the storage media 466. For example, the one or more storage media 426 may be electrical type storage media. Non-limiting examples of electrical type storage media include EEPROM's or other memory chips that can store information, or that can be programmed to store such information. More detailed descriptions of the sleeve and media interface housing are shown and described in commonly owned U.S. Pat. No. 11,650,380, which is incorporated herein in its entirety by reference.

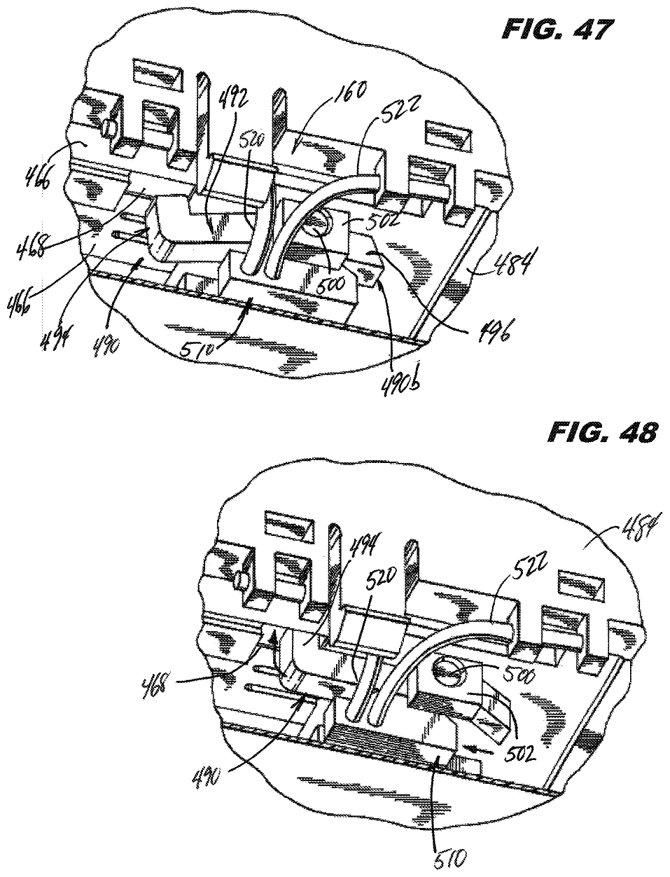

Continuing to refer to FIGS. 43-48, as noted, the port 480 is similar to, for example, known LC or MPO ports that can be operatively connected to a fiber connector 460, except the port 480 includes a locking assembly 482 attached to, e.g., releasably or permanently secured to, a housing 484 of the port 480. The port 480 may be mounted to a platform similar to platform 2000 described above. Non-limiting examples of a platform include printed circuit boards and surfaces of a housing or brackets within a housing of components within a datacenter. The locking assembly 482 includes a locking arm 490 and a slider 510. The locking arm 490 has a main bar 492, a locking bar 494 and a pivot bar 496. The locking arm 490 is pivotably secured to the housing 484 of the port 480 using pins 498 extending from side walls 490a of the locking arm 490. The pins 498 are received in openings 500, seen in FIG. 44, in pin brackets 502 extending from the housing 484. The locking bar 494 extends from the first end of the main bar 492 of the locking arm 490. The locking bar 494 is at an angle, preferably, about 90 degrees, relative to the main bar 492 so that the locking bar 494 can be received in the notch 488 in the media interface housing 464, seen in FIG. 44. The pivot bar 496 extends from a second end of the main bar 492 and is at an angle “a” relative to the main bar 492, as shown in FIG. 46. The angle “a” is configured to move, e.g., pivot, the main bar 492 so that the locking bar 494 can move between the unlocked position, where the locking bar 494 is removed from the notch 468 in the media interface housing 464, and the locked position, where the locking bar 494 is positioned in the notch 468 in the media interface housing 464. The slider 510 is configured and dimensioned to rest on an exterior surface 490b of the locking arm 490, seen in FIGS. 47 and 48, and is movable along the top surface 450b in response to the actuator 160 so that the locking assembly 482 moves between the unlocked position and the locked position. The slider 510, seen in FIG. 45, includes two openings 512 and 514 for connecting the actuator 160 to the slider 510.

The actuator 160 is an electronically controlled assembly or member where a controller 750, seen in FIG. 53, either internal or external to a housing of components within a datacenter, controls the operation of the actuator 160. More specifically, the actuator 160 is used to move the slider 510 of the locking assembly 482 along the exterior surface 490b of the locking arm 490 such that the locking arm 490 moves between the unlocked position, seen in FIG. 47, and the locked position, seen in FIG. 48. The actuator 160 may be an assembly of two or more components or the actuator 160 may be a single component or member. In the exemplary embodiment shown in FIGS. 47 and 48, the actuator 160 includes two or more components, namely push and/or pull member 520 and push and/or pull member 522. In the exemplary embodiment shown, the push and/or pull members 520 and 522 are springs made of a material having shape memory properties, such as a shape memory alloy. Non-limiting examples of shape memory alloys include Nitinol, Flexinol® and Muscle Wire. For this exemplary embodiment, the push and/or pull member 520 will be referred to as the spring 520 and the push and/or pull member 522 will be referred to as the spring 522. In this exemplary embodiment, the spring 520 has one end secured within opening 514 of the slider 510 and the other end of the spring 520 is secured to, for example, a fixed point on an exterior surface of the housing 484 of the port 480. However, the present disclosure contemplates that the actuator 520 may be secured to a fixed point within the housing 484 of the port 480. Similarly, the spring 522 has one end secured within opening 512 in the slider 510 and the other end of the spring 522 is secured to, for example, a fixed point on an exterior surface of the housing 484 of the port 480. However, the present disclosure contemplates that the actuator 522 may be secured to a fixed point within the housing 484 of the port 480.

Moving the slider 510 relative to the locking arm 490 to move the locking assembly 482 between the unlocked position and the locked position will be described with reference to FIGS. 47 and 48. As noted, the actuator 160 is electrically and/or operatively connected to the controller 750, seen in FIG. 53, so that the controller 750 can apply a signal, e.g., a current, that activates spring 520 or spring 522 to move the slider 510 along the exterior surface 490b of the locking arm 490 such that the locking arm 490 moves between the unlocked and locked positions. The starting point in this example is with the locking assembly 482 in the locked position where the slider is resting on the main bar 492 of the locking arm 490 and the locking bar 494 is inserted into the notch 468 in the media interface housing 464. To move the locking arm 490 to the unlocked position, the controller 750 applies a signal, e.g., a current, to the actuator 522 causing the slider 510 to move along the main bar 492 toward the pivot bar 496 of the locking arm 490. As the slider 510 moves along the pivot bar 496, the slider 510 causes the locking bar 494 of the locking arm 490 to move, e.g., pivot, out of the notch 468 in the in the media interface housing 464. In the unlocked position, the connector 460 is unlocked from the port 480 allowing the connector 460 to be removed from the port 480 or permitting a connector to be inserted into the port 480.

Continuing to refer to FIGS. 47 and 48, to move the locking arm 490 from the unlocked position to the locked position, the controller 750 applies a signal, e.g., a current, to the actuator 520 causing the slider 510 to move from the pivot bar 496 of the locking arm 490 onto the main bar 492 causing the locking bar 494 of the locking arm 490 to move, e.g., pivot, into the notch 468 in the media interface housing 464. In the locked position, the connector 460 is prevented from being removed from or inserted into the port 480.

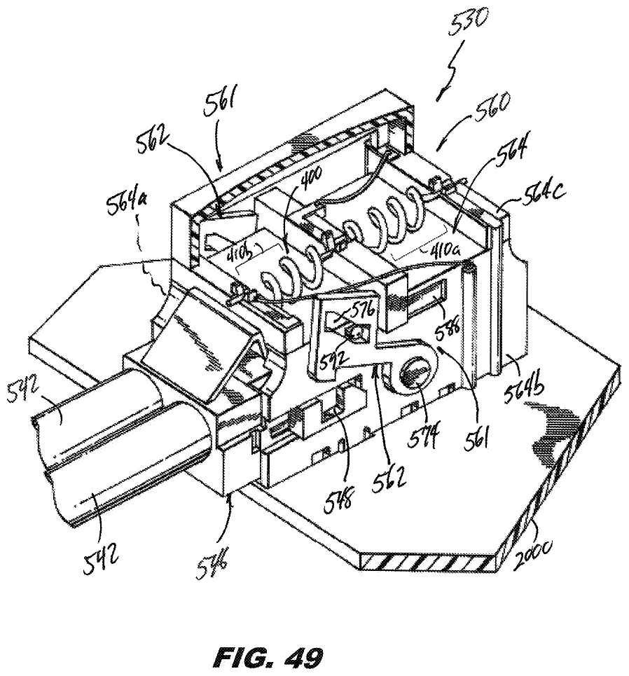

Referring now to FIGS. 49-52, another exemplary embodiment of a fiber mating assembly 530 is shown. The fiber mating assembly 530 includes a paired single fiber connector 540 and a paired single fiber port 560. The paired single fiber connector 540 may also be referred to herein as the “connector 540.” The paired single fiber port 560 may also be referred to herein as the “port 560.” Each connector 540 of the paired fiber connectors is similar to, for example, known LC connectors that can be operatively connected to single fiber cables 542, except the connector 540 includes a clip member 544. The clip member 544 may be integrally or monolithically formed into a housing 546 of the connector 540, or the clip member 544 may be releasably or permanently secured to the housing 546 of the connector 540. The clip member 544 includes one or more locking notches 548 that are configured and dimensioned to be captured by locking assembly 561 of the port 560 as described below.

While the fiber mating assembly 530 is described a paired single fiber connector 540 and a paired single fiber port 560, the present disclosure contemplates that the fiber mating assembly 530 may include multi-fiber connectors and multi-fiber ports. The multi-fiber connector may be similar to, for example, known MPO connectors that can be operatively connected to a multi-fiber cable. It is noted that the fiber mating assembly 530 and the other fiber mating assemblies described herein may include a multi-fiber connector and a multi-fiber port instead of single fiber connectors and ports. When using multi-fiber connectors and ports, the multi-fiber connector may be, for example, known MPO connectors and ports, where the multi-fiber connector can be operatively connected to a multi-fiber cable. When using multi-fiber connectors and ports, the multi-fiber connector may use a sleeve positioned over the multi-fiber cable connector and attached to the multi-fiber cable connector. The sleeve may include a media interface housing that is configured to receive one or more storage media, similar to the storage media 466 described above. For example, the one or more storage media may be electrical type storage media. Non-limiting examples of electrical type storage media include EEPROM's or other memory chips that can store information, or that can be programmed to store such information. More detailed descriptions of the sleeve and media interface housing are shown and described in commonly owned U.S. Pat. No. 11,650,380, which is incorporated herein in its entirety by reference.

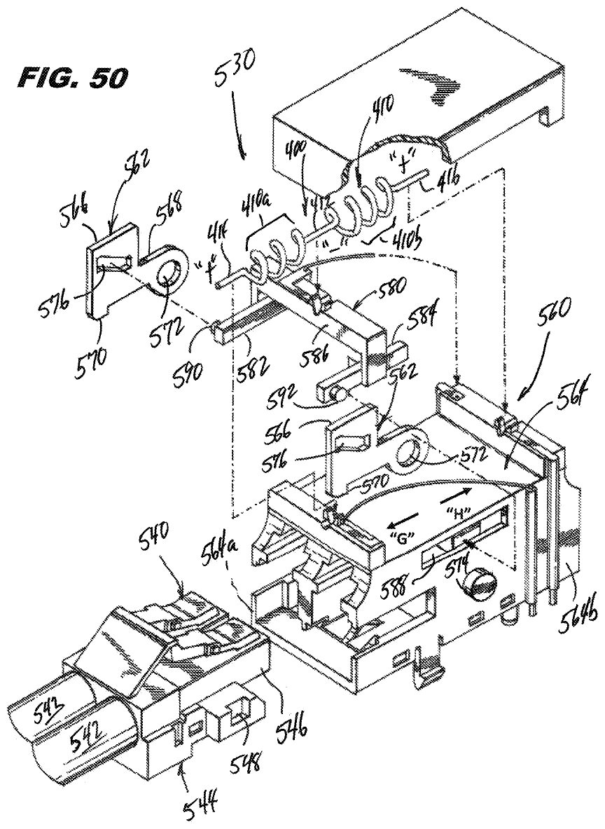

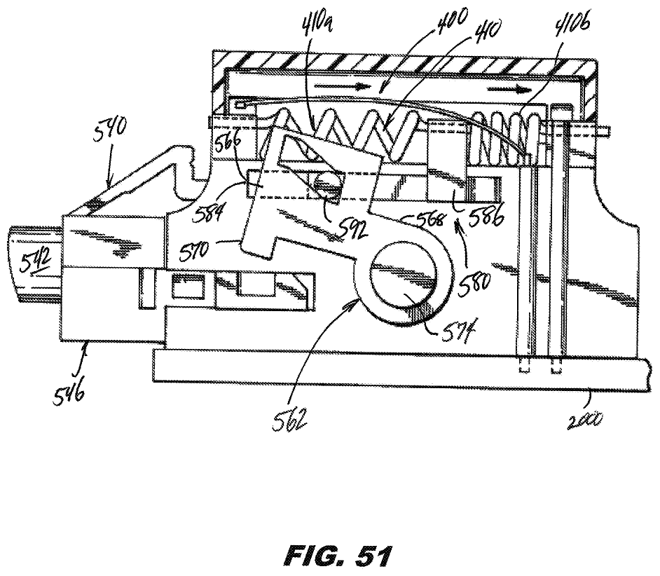

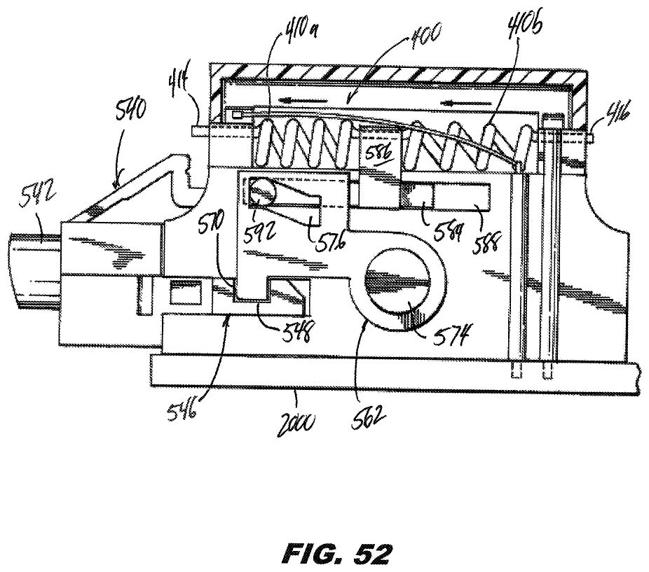

Continuing to refer to FIGS. 49 and 50, the port 560 is similar to known LC ports that can be operatively connected to a single fiber connector 540, except the port 560 includes a locking assembly 561 and an actuator 400. The port 560 may be mounted to a platform similar to platform 2000 described above. Non-limiting examples of a platform include printed circuit boards and surfaces of a housing or brackets within a housing of components within a datacenter. The locking assembly 561 includes one or more movable locking members 562 and a slider 580. It is noted that the one or more locking notches 548 of the clip member 544 may be considered part of the locking assembly 561. The one or more movable locking members 562 may be releasably or permanently secured to the housing 564 and are movable, e.g., pivotable, relative to the housing 564 of the port 560. In the embodiment shown, there are two locking members 562. Each locking member 562 includes a main body 566, a pivot arm 568 and a locking bar 570. The pivot arm 568 extends from the main body 566, as shown in FIG. 50, and includes a pin aperture 572 used to movably attach each locking arm 562 to the housing 564 of the port 560. Each pin aperture 572 is configured to receive a pin 574 extending from side walls 564a and 564b of the housing 564 of the port 560. The locking bar 570 extends from the main body 566 and is configured to be received within the notch 548 of the clip member 546, as shown in FIG. 52. The locking bar 570 is at an angle, preferably, about 90 degrees, relative to the main body 566. The main body 566 also includes a track 576 that is configured to move, e.g., pivot, the locking bar 570 of the locking members 562 between unlocked and locked positions. When in the locked position, seen in FIG. 52, the locking bar 570 is positioned in the notch 548 of the clip member 546 to block the one or more clip members 546 from moving so that the connector 540 cannot be removed from the port 560. When in the unlocked position, seen in FIG. 51, the locking bar 570 is removed from the notch 548 of the clip member 546 so that the connector 540 can be removed from or inserted into the port 560.

The slider 580 includes a first rail 582, a second rail 584 and a connecting arm 586 between the first rail 582 and the second rail 584. The first rail 582 is configured to slide within a track (not shown) within side 564a of the housing 564 of the port 560. The track is the same as the track 588 described below and shown in FIG. 50. The second rail 584 is configured to slide within track 588 within side 564b of the housing 564 of the port 560. The first rail 582 includes a glide pin 590 configured and dimensioned to fit within the track 576 in the main body 566 of the first locking member 562, and the second rail 584 includes a glide pin 592 configured and dimensioned to fit within the track 576 in the main body 566 of the second locking member 562. In this configuration, movement of the slider 590 relative to the housing 564 causes the locking members 562 to move the locking bars 570 between the unlocked position and the locked position.

Referring again to FIG. 50, the actuator 400 is used to move the locking assembly 561 between an unlocked position, seen in FIG. 51, and a locked position, seen in FIG. 52. The actuator 400 may be an assembly of two or more components or the actuator 400 may be a single member. In this exemplary embodiment, the actuator 400 is a single member, which is the same as the actuator 400 described above. The actuator 400 is mounted to a top exterior surface 564c of the housing 564 of the port 560. However, the present disclosure contemplates that the actuator 400 may be within the housing 564 of the port 560. The actuator 400 is electrically and/or operatively connected to the controller 750, seen in FIG. 53, so that the controller can apply a signal, e.g., a current, that activates the actuator 400 to move the locking assembly 561 between the locked and unlocked positions. In the exemplary embodiment shown, the actuator 400 is a push and/or pull member 410. The push and/or pull member 410 may be a spring. For this exemplary embodiment, the push and/or pull member will be referred to as the spring 410. The spring 410 may be made of a material having shape memory properties, such as a shape memory alloy and solenoids. Non-limiting examples of a shape memory alloys include Nitinol, Flexinol® and Muscle Wire. The spring 410 is preferably a two-way shape-memory alloy having two portions 410a and 410b. As shown in FIGS. 51 and 52, to move the locking assembly 561 from the unlocked position to the locked position, the first portion 410a of the spring 410 is activated by the controller 750 via a cable similar to cable 51. Activating the first portion 410a of the spring 410 heats the first portion 410a which compresses the first portion 410a pulling the slider 580 of the locking assembly 561 in the direction of arrow “G” toward the connector 540. The pulling force on the slider 580 moves, e.g., slides, the slider along the tracks 588 in the housing 564 so that the pins 590 and 592 within the tracks 576 of the locking arms 562 slide along the tracks 576. Sliding the pins 590 and 592 along the tracks 576 causes the locking arms 562 to move, e.g., pivot, to the locked position. In the locked position, the locking bars 570 of the locking arms 562 are positioned within the locking notches 548 of the clip member 546. With the locking bars 570 positioned within the locking notches 548, the locking bars 570 block the clip member 546 from moving so that the connector 540 cannot be removed from the port 560 or inserted into the port 560, as shown in FIG. 52.

Referring to FIGS. 51 and 52, to move the locking assembly 561 from the unlocked position to the locked position, the second portion 410b of the spring 410 is activated by the controller 750 via a cable similar to cable 51. Activating the second portion 410b of the spring 410 heats the second portion 410b which compresses the second portion 410b pulling the slider 580 of the locking assembly 561 in the direction of arrow “H” away from the connector 540. The pulling force on the slider 580 moves, e.g., slides, the slider along the tracks 588 in the housing 564 so that the pins 590 and 592 within the tracks 576 of the locking arms 562 slide along the tracks 576. Sliding the pins 590 and 592 along the tracks 576 causes the locking arms 562 to move, e.g., pivot, to the unlocked position. In the unlocked position, the locking bars 570 of the locking arms 562 are removed from the locking notches 548 of the clip member 546, as shown in FIG. 51. With the locking bars 570 removed from the locking notches 548, the connector 540 is free to move. With the connector 540 free to move, the connector 540 may be removed from the port 560 or inserted into the port 560.

Referring to FIG. 53, an exemplary embodiment for controlling the operation of the various actuators described herein is described. When a controller 750, e.g., a processor, a microcontroller, or an ASCI, detects the presence of a connector, e.g., connector 20, 120, 360, 460 or 540, inserted into a port, e.g., port 40, 140, 380, 480, the controller 750 enables the actuator associated with the port to move the locking assembly between the unlocked position and the locked position. With the actuator enabled, the locking assembly can be moved between the locked and unlocked positions in a number of ways. In an exemplary embodiment, the application 752 or a user interface (not shown) can generate a command or signal instructing the controller 750 to enable the power circuit 754 to send a signal, such as apply a current, to one or more springs or wires W1 and/or W2 associated with a port via a cable 51. As noted above, the actuator may be one or more components or members made of material with shape memory properties, such as shape memory alloys. Applying a current to the springs or wires W1 may cause the actuator to move the locking system to the locked position, and applying a current to the springs or wires W2 may cause the actuator to move the locking system to the unlocked position. In this configuration, the controller 750 can remotely lock and unlock a cable connector to a port.

In another exemplary embodiment, when the controller 750 does not detect the presence of a cable connector in a port, the controller 750 may enable the actuator associated with the port to move the locking assembly between the locked position and the unlocked position. In this embodiment, the controller 750 can control whether or not a connector can be inserted into a particular port. With the port actuator enabled, the locking member or locking assembly can be moved between the locked and unlocked positions in a number of ways. In an exemplary embodiment, the application 752 or a user interface (not shown) can generate a command or signal instructing the controller 750 to enable the power circuit 754 to apply a current to the W1 wire or the W2 wire. As noted above, the actuator may be one or more muscle wires such that applying a current to the muscle wire W1 may cause the actuator to move the locking member or system to the locked position, and applying a current to the muscle wire W2 may cause the actuator to move the locking member or system to the unlocked position. Non-limiting examples of the current used to activate the muscle wire range from about 3 amps to about 6 amps at about 2.5 VDC and at temperatures ranging between 30 degrees Celsius and about 75 degrees Celsius.

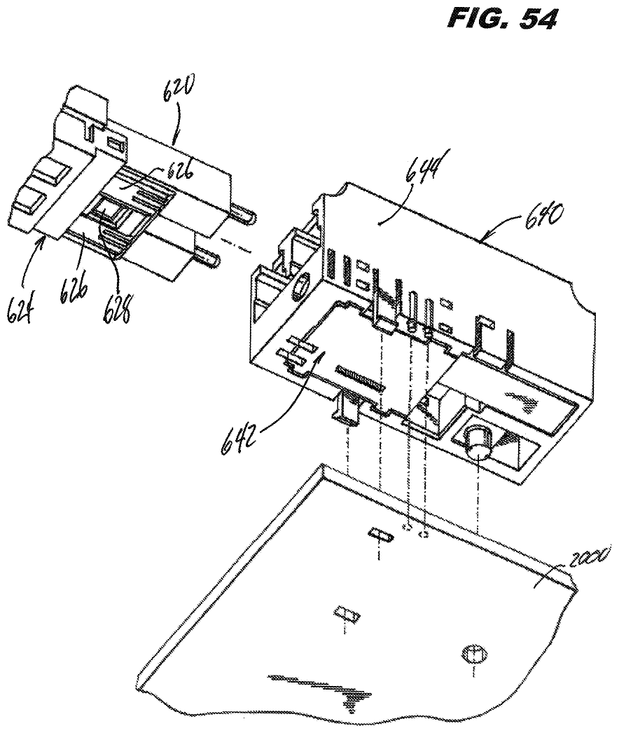

Referring now to FIGS. 54-58, another exemplary embodiment of a fiber mating assembly 600 is shown. The fiber mating assembly 600 may include a paired single fiber connector 620 and a paired single fiber port 640. The paired single fiber connector 820 may also be referred to herein as the “connector 620.” The paired single fiber port 640 may also be referred to herein as the “port 640.” Each connector of the paired fiber connector 820 is similar to, for example, known LC connectors that can be operatively connected to single fiber cables. The connector 620 may include a media interface housing 624 that is configured to receive one or more storage media 626, seen in FIG. 54. In this exemplary embodiment, the one or more storage media 626 are electrical type storage media. Non-limiting examples of electrical type storage media include EEPROM's or other memory chips that can store information, or that can be programmed to store such information. The information stored on the storage media 626 includes, for example, identifying data and cable characteristics. Non-limiting examples of the connector identifying data and cable characteristics include connector ID, connector type, cable color, cable length, cable ID, cable fiber type, and any other desired information. A more detailed description of the media interface housing 824 is shown and described in commonly owned U.S. Pat. No. 11,650,380, which is incorporated herein in its entirety by reference. The media interface housing 624 also includes a locking opening 628, seen in FIG. 54, which in this example is between two storage media 626. The locking opening 628 is used when locking the fiber mating assembly 600 of the port 640 to the connector 620, as described in more detail below.

In another embodiment, the fiber mating assembly 600 may include a multi-fiber connector and a multi-fiber port that are similar to the multi-fiber connector and multi-fiber port described above. As described above, the multi-fiber connector may be similar to, for example, known MPO connectors that can be operatively connected to a multi-fiber cable. The fiber mating assembly 600 may also include a sleeve positioned over the fiber cable connector and attached to the fiber cable connector. The sleeve may include a media interface housing, similar to the media interface housing 624, that is configured to receive one or more storage media, which is similar to the one or more storage media 626 described above. The media interface housing would also include the locking opening, that may be similar to the locking opening 828 described above. The locking opening would be used when locking the fiber mating assembly 600 to the port 640 as described in more detail below.

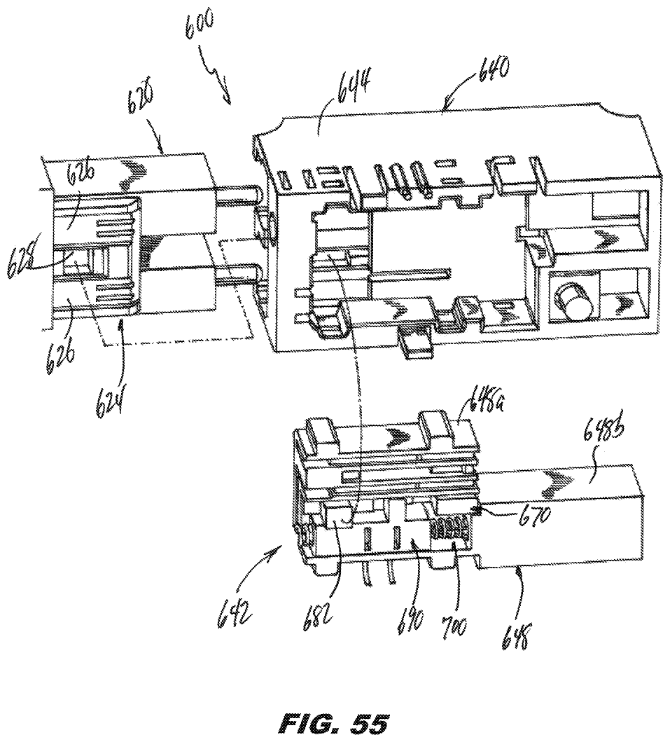

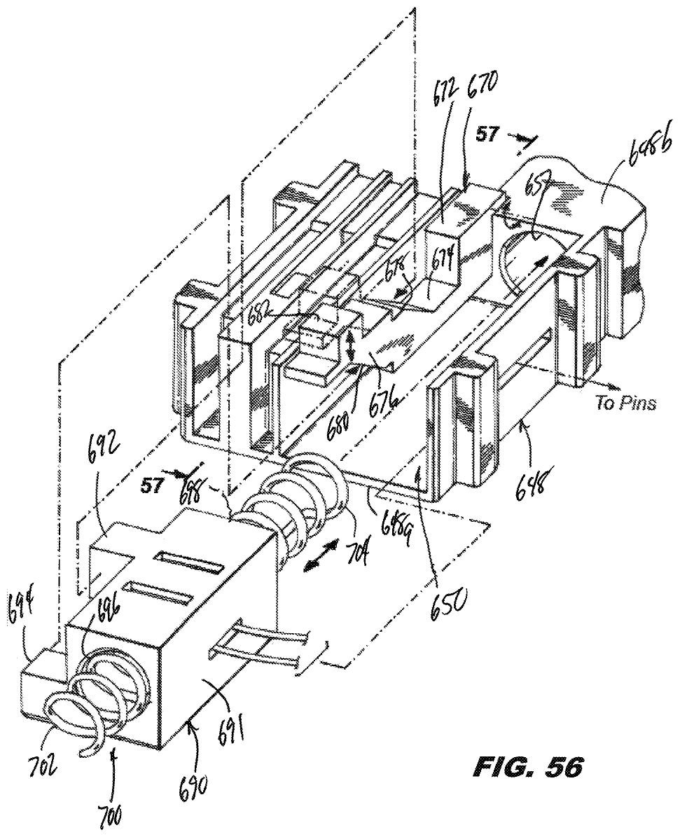

Continuing to refer to FIGS. 54-58, as noted, the port 640 is similar to, for example, known LC or MPO ports that can be operatively connected to a fiber connector 620, except the port 640 includes a locking assembly 642 attached to, e.g., releasably or permanently secured to, a housing 644 of the port 640. The port 640 may be mounted to a platform similar to platform 2000 described above, shown in FIG. 54. Non-limiting examples of a platform include printed circuit boards and surfaces of a housing or brackets within a housing of components within a datacenter. The locking assembly 642 includes a locking assembly body 648, a locking arm 670 and a slider 690. The locking assembly body 648 may include a slider holding portion 648a and an actuator holding portion 648b. The slider holding portion 648a includes a channel 650, seen in FIG. 56, configured and dimensioned to receive the locking arm 670 and the slider 690. Preferably, the locking arm 670 is fixed in position within the channel 650, and the slider 690 is longitudinally slidable within the channel 650 and operatively associated with the fixed locking arm 670. The locking arm 670 may be fixed in position within the channel 650 by integrally or monolithically forming at least a portion of the locking arm 670 into one or more walls of the channel 650. The actuator holding portion 648b is preferably integrally or monolithically formed into the slider holding portion 648a so that the actuator holding portion 648b is aligned with the channel 650, as shown in FIG. 55. However, the actuator holding portion 648b may be secured to the slider holding portion 648a using for example, welds, adhesives and/or mechanical fasteners, such as a snap-fit connection. The actuator holding portion 648b is provided to hold at least a portion of an actuator 700, seen in FIG. 56, which is described in more detail below. In the embodiment shown, the actuator holding portion 648b includes an opening 652 configured and dimensioned to receive at least a portion of the actuator 700.

Referring to FIGS. 56-58, the locking arm 670 has a main portion 672, a flex portion 674 and a locking portion 676. As noted, the locking arm 670 is secured within the channel 650 so that the locking arm is in a fixed position. As an example, at least the main portion 672 of the locking arm 670 may be secured to the locking assembly body 648 using, for example, welds, adhesives and/or mechanical fasteners such as a snap-fit connection. The first end of the flex portion 674 is preferably integrally or monolithically formed to the main portion 672 and extends from the first end of the main portion 672, as shown. In another embodiment, the first end of the flex portion 674 may be secured to the main portion 672 using, for example, welds, adhesives and/or mechanical fasteners such as a snap-fit connection. The flex portion 674 is provided to flex in response to movement of the slider 690 as it acts on the locking portion 676, which is described below. The first end of the locking portion 676 is preferably integrally or monolithically formed to a second end of the flex portion 674 and extends from the second end of the flex portion 674. In another embodiment the first end of the locking portion 676 may be secured to the flex portion 674 using, for example, welds, adhesives and/or mechanical fasteners such as a snap-fit connection. The locking portion 676 includes a first camming surface 678 and a second camming surface 680, seen in FIG. 56. The first camming surface 678 is positioned to interact with a first camming arm 692 on the slider 690, and the second camming surface 680 is positioned to interact with a second camming arm 694 on the slider 690. The first camming surface 678 and the second camming surface 680 are at an angle relative to a longitudinal axis of the locking assembly body 648. The angle is configured to move, e.g., flex, the locking portion 676 so that a locking member 682 of the locking portion 676 is moved between an unlocked position where the locking member 682 is removed from the opening 628 in the media interface housing 624 and a locked position where the locking member 682 is positioned within the opening 628 in the media interface housing 624.

Referring again to FIGS. 55 and 56, an exemplary embodiment of the slider 690 is shown. In the exemplary embodiment shown, the slider 690 has a body 691, the first camming arm 892 and the second camming arm 694. The body 692 may also include a first opening 696 and a second opening 698. The first opening 696 is configured and dimensioned to receive at least a portion of the actuator 700. The second opening 698 is configured and dimensioned to receive at least another portion of the actuator 700. The second opening 698 is aligned with the opening 652 in the actuator holding portion 648b. In the exemplary embodiment shown, the body 692 of the slider 690 is a rectangular shaped block-like structure that includes the first camming arm 692 extending from a side of the body 891, and the second camming arm 694 extends from the same side of the body 692 as the first camming arm 692. The slider 690 rests on the top surface of the channel 650 and is movable along the top surface of the channel 650 in response to the actuator 700 so that the locking assembly 642 moves between the unlocked position and the locked position. As noted, when in the unlocked position, the locking member 682 of the locking arm 670 is removed from the opening 628 in the media interface housing 624, and when in the locked position, the locking member 682 of the locking arm 670 is positioned within the opening 628 in the media interface housing 624. In the exemplary embodiment of FIGS. 54-58, the actuator 700 may be an assembly of two or more components or the actuator 700 may be a single component or member. In the exemplary embodiment shown, the actuator 700 is an assembly of two or more components that includes a first push and/or pull member 702 and second push and/or pull member 704. In the exemplary embodiment shown, the push and/or pull member 702 is a spring made of a material having shape memory properties, such as a shape memory alloy. Non-limiting examples of shape memory alloys include Nitinol, Flexinol® and Muscle Wire. Similarly, the second push and/or pull member 704 is a spring made of a material having shape memory properties, such as a shape memory alloy. Non-limiting examples of shape memory alloys include Nitinol, Flexinol® and Muscle Wire. For this exemplary embodiment, the first push and/or pull member 702 will be referred to as spring 702, and the second push and/or pull member 704 will be referred to as spring 704.

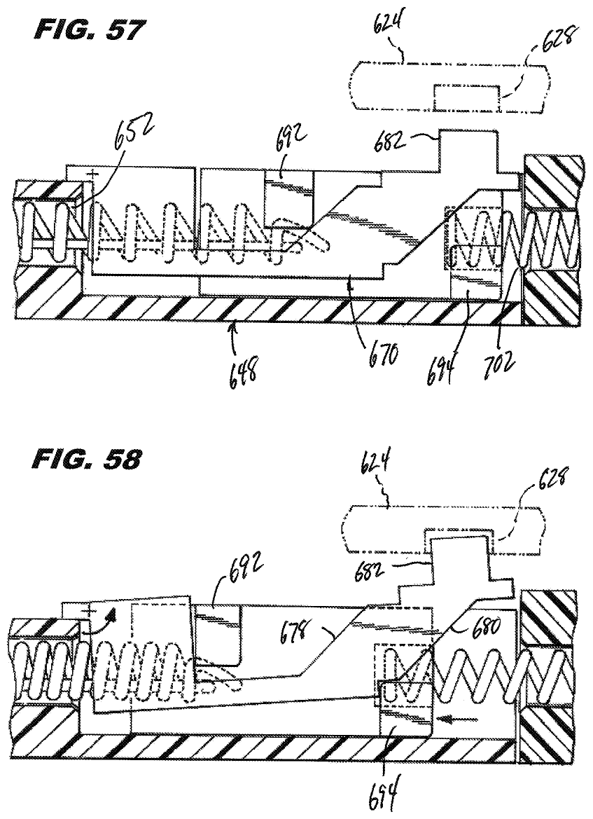

Referring to FIGS. 56-58, the slider 690 has two openings 696 and 698 in which the actuator 700 is operatively coupled or connected to the slider 690. The locking member 642 of the fiber mating assembly 600 is an electronically controlled member where a controller 750, seen in FIG. 53, either internal or external to a housing of components within a datacenter, controls the operation of the locking member 642. More specifically, the actuator 700 is used to move the locking member 642 between the unlocked position where the locking member 682 is removed the opening 628 in the media interface housing 624 and the locked position where the locking member 682 is within the opening 528 in the media interface housing 624. The springs 702 and 704 of the actuator 700 are electrically and/or operatively connected to the controller 750 so that the controller can apply a signal, e.g., a current, that activates one of the two springs 702 or 704 to move the locking assembly 642 between the locked and unlocked positions. To move the locking assembly 642 to the unlocked position, the spring 702 is activated by applying a current to the spring causing the spring 702 to heat and compress the spring 702. Compressing the spring 702 causes the slider 690 to move in the channel 650 so that a cam surface of the camming arm 692 moves along the first camming surface 678 of the locking portion 676. Movement of the camming arm 692 along the first camming surface 678 causes the locking portion 676 to move, e.g., flex, downward so that the locking member 682 of the locking portion 676 moves out of the opening 628 in the media interface housing 624, as shown in FIG. 57. When in the unlocked position, the connector 620 can be inserted into or removed from the port 640. To move the locking assembly 642 to the locked position, the spring 704 is activated by applying a current to the spring causing the spring 704 to heat and compress the spring 702. Compressing the spring 704 causes the slider 690 to move in the channel 650 so that a cam surface of the camming arm 694 moves along the second camming surface 680 of the locking portion 676. Movement of the camming arm 694 along the second camming surface 680 causes the locking portion 676 to move, e.g., flex, upward so that the locking member 682 of the locking portion 676 moves into the opening 628 in the media interface housing 624, as shown in FIG. 58. In the locked position, the connector 620 is prevented from being removed from or inserted into the port 640.

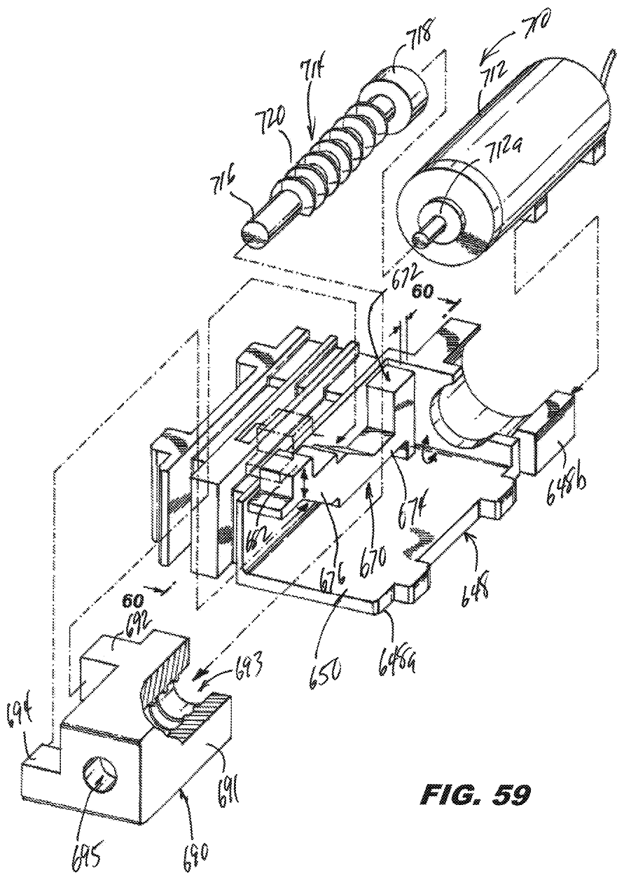

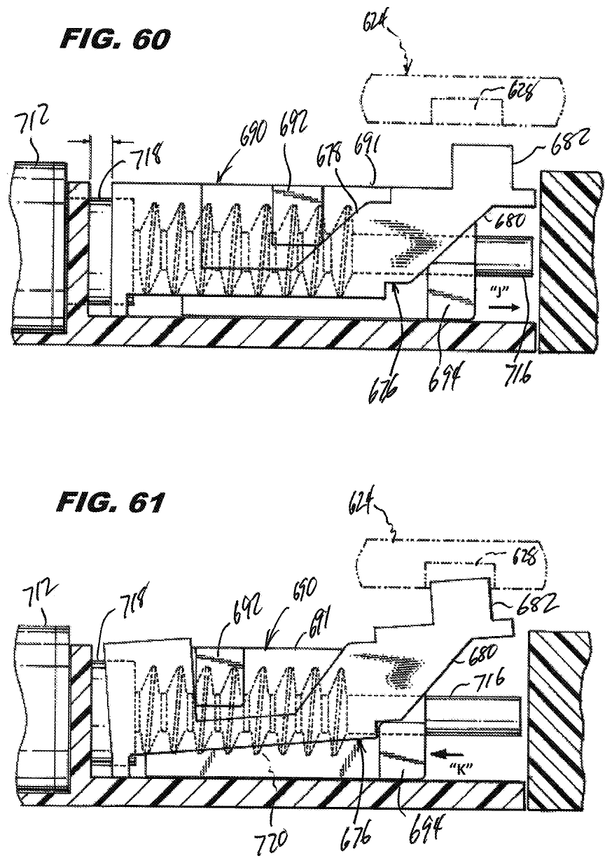

Referring to FIGS. 59-62, another exemplary of the locking assembly 642 attached to, e.g., releasably or permanently secured to, a housing 644 of the port 640 is shown. This embodiment is substantially similar to the embodiment of FIGS. 54-58 such that like numerals are used for like elements. In this exemplary embodiment, the slider 690 and the actuator 700 of the locking assembly 642 differ. The slider 690 includes a threaded aperture 693 extending into the body 691 from one end, and a shaft receiving aperture 695 that begins at the end of the threaded aperture 693 and exits the second end of the body 691. The actuator 700 of the locking assembly 642 is a motor assembly 710 having a motor 712 and a drive gear 714. The actuator holding portion 648b of the locking assembly body 648 is adapted to receive the motor 712 of the motor assembly 710. The motor 712 may be a known DC controlled stepper motor. The drive gear 714 includes a motor coupling portion 716, a threaded portion 718 and a shaft portion 720. The drive gear 714 is preferably a worm gear having a shaft 716 that includes a motor coupling portion 718 at the proximal end of the shaft 716 and a threaded portion 720. The motor coupling portion 718 is configured to attach to a spindle 712a of the motor 712. The threaded portion 720 is configured to interact with the threaded aperture 693 in the body 691 of the slider 690. The distal end of the shaft 716 is passed through the threaded aperture 693 so that at least a portion of the shaft 716 passes through the shaft receiving aperture 695 in the body 691. Rotation of the motor in one direction, e.g., a clockwise direction, causes the slider 690 to move in the direction of arrow “J.” Moving the slider 690 in the direction of arrow “J” causes the camming arm 692 of the slider 690 to move along the first camming surface 678 causing the locking portion 676 of the slider 690 to move, e.g., flex, downward so that the locking member 682 of the locking portion 676 moves out of the opening 628 in the media interface housing 624, as shown in FIG. 61. When in the unlocked position, the connector 620 can be inserted into or removed from the port 640. Rotation of the motor in the opposite direction, e.g., a counterclockwise direction, causes the slider 690 to move in the direction of arrow “K.” Moving the slider 690 in the direction of arrow “K” causes the camming arm 694 to move along the second camming surface 680 causing the locking portion 676 to move, e.g., flex, upward so that the locking member 682 of the locking portion 676 moves into the opening 628 in the media interface housing 624, as shown in FIG. 61. In the locked position, the connector 620 is prevented from being removed from or inserted into the port 640.

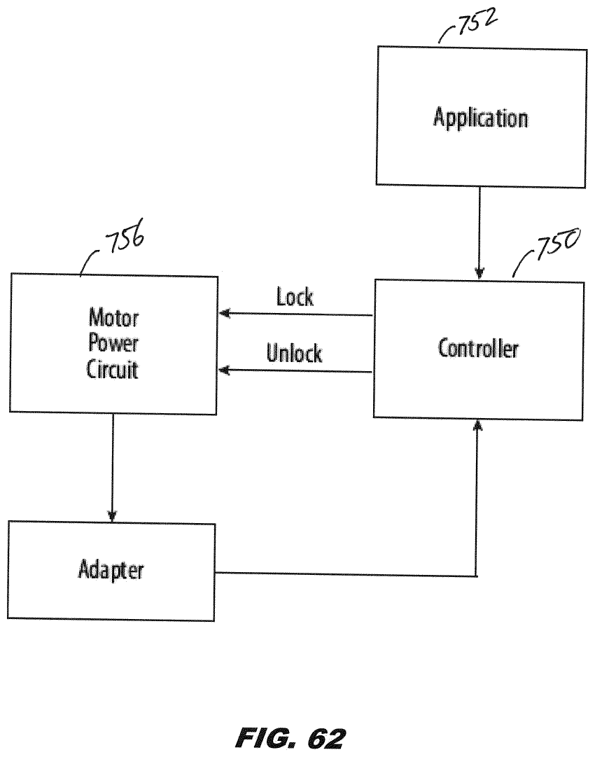

Referring to FIG. 62, an exemplary embodiment for controlling the operation of the motor assembly 710 is described. When a controller 750, e.g., a processor, a microcontroller, an ASCI, detects the presence of a cable connector inserted into a port, the controller 750 enables the actuator 700 to move the locking assembly 642 between the locked position and the unlocked position. With the port actuator energized, the locking assembly 642 can be moved between the locked and unlocked positions in a number of ways. In an exemplary embodiment, the application 752 or a user interface (not shown) can generate a command or signal instructing the controller 750 to enable the motor power circuit 756 to apply a current to the motor 712 of the motor assembly 710 to rotate the motor in a forward direction or to rotate the motor 712 in a backward direction. For example, rotating the motor 712 in the forward direction may cause the motor assembly 710 to move the locking assembly 642 to the unlocked position, and rotating the motor 712 in the reverse direction may cause the motor assembly 710 to move the locking assembly 642 to the locked position. In another exemplary embodiment, when the controller does not detect the presence of a cable connector in a port, the controller may enable the motor assembly 710 associated with the port to move the locking member or locking assembly between the locked position and the unlocked position. In this embodiment, the controller can control whether or not a connector 620 can be inserted into a particular port 640. With the motor assembly 710, the locking assembly 642 can be moved between the locked and unlocked positions in a number of ways. In an exemplary embodiment, the application 752 or a user interface (not shown) can generate a command or signal instructing the controller 750 to enable the motor power circuit 756 to apply a current to the motor 712. For example, rotating the motor 712 in the forward direction may cause the motor assembly 710 to move the locking assembly 642 to the unlocked position, and rotating the motor 712 in the reverse direction may cause the motor assembly 710 to move the locking member or system to the locked position, where a connector 620 is prevented from being inserted into a particular port 640.

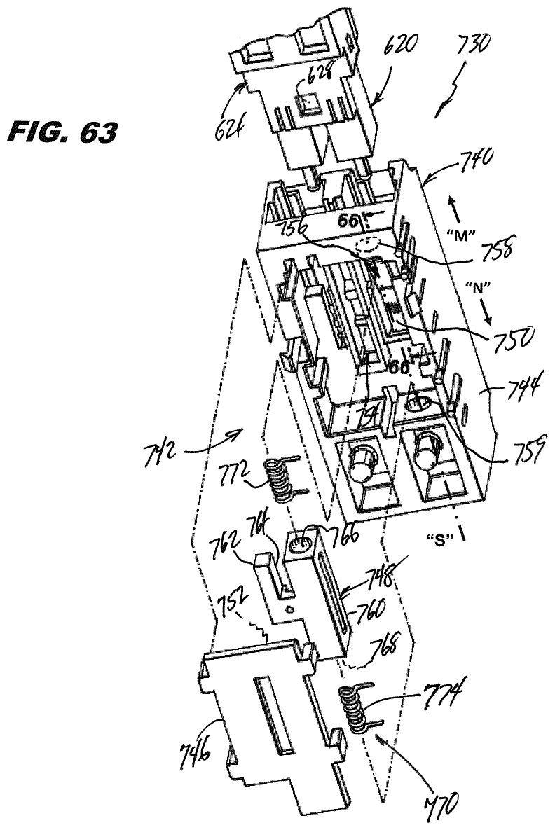

Referring now to FIGS. 63-68, another exemplary embodiment of a fiber mating assembly 730 is shown. The fiber mating assembly 730 may include a connector 620 and a fiber port 740. In the embodiment shown, the connector 620 includes a paired single fiber connector 620 and the fiber port 740 includes a paired single fiber port 740. The fiber port 740 may also be referred to herein as the “port 740.” Each connector of the connector 620 is similar to, for example, known LC connectors that can be operatively connected to single fiber cables. The connector 620 may include a media interface housing 624 that may be configured to receive one or more storage media 626 as described above. The media interface housing 624 also includes a locking opening 628, which in this example is in a center portion of the storage media section of the media interface housing 624. The locking opening 628 is used when locking the fiber mating assembly 730 to the port 740 as described in more detail below.

In another embodiment, the fiber mating assembly 730 may include a multi-fiber connector and a multi-fiber port that are similar to the multi-fiber connector and a multi-fiber port described above. As described above, the multi-fiber connector is similar to, for example, known MPO connectors that can be operatively connected to a multi-fiber cable. The fiber mating assembly 730 may also include a sleeve, which is similar to the sleeve described above, that is positioned over the multi-fiber cable connector and attached to the multi-fiber cable connector. The sleeve may include the media interface housing 624 described herein. More detailed descriptions of the sleeve and media interface housing are shown and described in commonly owned U.S. Pat. No. 11,650,380, which is incorporated herein in its entirety by reference. The media interface housing 624 would also include the locking opening 628 which in this example is in a center portion of the storage media section of the media interface housing 624. The locking opening 628 is used when locking the connector 620 described herein to the port 740 described in more detail below.

Continuing to refer to FIG. 63, as noted, the port 740 is similar to, for example, known LC or MPO ports that can be operatively connected to a fiber connector 620, except the port 740 includes a locking assembly 742 attached to, e.g., releasably or permanently secured to, a housing 744 of the port 740. The port 740 may be mounted to a platform similar to platform 2000 described above. Non-limiting examples of a platform include printed circuit boards and surfaces of a housing or brackets within a housing of components within a datacenter. The locking assembly 742 includes a locking assembly body 746, a locking arm 670, a slider 748 and a connector blocker 750. The locking assembly body 746 may include a slider holding portion 752. The slider holding portion 752 includes a channel configured and dimensioned to receive the slider 748. Preferably, the locking arm 670 is fixed in position within a channel 754 in the housing 744 of the port 740. The slider 748 is longitudinally slidable within the channel of the slider holding portion 752 and a channel 756 within the housing 744 of the port 740. In this configuration, the slider 748 is positioned relative to the locking arm 670 so that the slider 748 is operatively associated with the locking arm 670. It is noted that the locking arm 670 is the same as the locking arm 670 described above such that like reference numerals are used for like elements and a detailed description of the locking arm 670 is not repeated.

Continuing to refer to FIG. 63, an exemplary embodiment of the slider 748 is shown. The slider 748 includes a main body 760 and a driver arm 762 that extends from the main body 760. The driver arm 762 of the slider 748 includes a camming surface 764. The driver arm 762 extends into the channel 754 in the housing 744 so that the camming surface 764 rests on the locking arm 670. In this configuration, as the slider 748 moves within the channel 756 within the housing 744 along axis “S,” the camming surface 764 of the driver arm 762 operatively interacts with the locking arm 670 moving, e.g., pivoting, the locking arm 670 between a locked position and an unlocked position. In the exemplary embodiment shown, the main body 760 of the slider 748 is a rectangular block-like structure that may also include a first opening 766 in the first end of the main body 760 and a second opening 768 in a second end of the main body 760. The first and second openings 766 and 768 are configured to receive the actuator 770. In this exemplary embodiment, the actuator 770 includes two push and/or pull members that includes a first push and/or pull member 772 and a second push and/or pull member 774. The first and second push and/or pull members 772 and 774 may be springs made of a material having shape memory properties, such as a shape memory alloy. Non-limiting examples of shape memory alloys include Nitinol, Flexinol® and Muscle Wire. For this exemplary embodiment, the first push and/or pull member will be referred to as spring 772, and the second push and/or pull member will be referred to as spring 774. The first end of spring 772 is secured withing the opening 766 in the slider 748 and the second end of spring 772 is secured within the opening 758 in the housing 744. Similarly, the first end of spring 774 is secured withing the opening 768 in the slider 748 and the second end of spring 774 is secured within the opening 759 in the housing 744.

Continuing to refer to FIG. 63, as noted the camming surface 764 of the driver arm 762 operatively interacts with the locking arm 670 so that as the slider 748 moves within the channel 756 within the housing 744 along axis “S” in the direction of arrow “M”, the camming surface 764 moves along the second camming surface 680 of the locking portion 676 of the locking arm 670 causing the locking portion 676 to move, e.g., flex, so that the locking member 682 of the locking portion 676 moves into the opening 628 in the media interface housing 624 locking the connector 620 to the port 740. In the locked position, the connector 620 is prevented from being removed from or inserted into the port 740. Moving the slider 748 within the channel 756 within the housing 744 along axis “S” in the direction of arrow “N,” the camming surface 764 moves in a reverse direction along the second camming surface 680 of the locking portion 676 causing the locking portion 676 to move, e.g., unflex, so that the locking member 682 of the locking portion 676 moves out of the opening 628 in the media interface housing 624 so that the locking portion 676 is in an unlocked position. As noted, when in the unlocked position, the locking member 682 of the locking arm 670 is removed from the opening 628 in the media interface housing 624, and when in the locked position, the locking member 682 of the locking arm 670 is positioned within the opening 628 in the media interface housing 624.

The springs 772 and 774 are operatively coupled or connected to the slider 748. The locking assembly 742 of the fiber mating assembly 730 is an electronically controlled assembly where a controller 750, seen in FIG. 53, either internal or external to a housing of components within a datacenter, controls the operation of the locking assembly 742. More specifically, the actuators 772 and 774 are used to move the slider 748 causing the locking assembly 742 to move between the unlocked position where the locking member 682 is removed the opening 628 in the media interface housing 624, and the locked position where the locking member 682 is within the opening 628 in the media interface housing 624, as described above. The springs 772 and 774 are electrically and/or operatively connected to the controller 750 so that the controller can apply a signal, e.g., a current, that activates one of the two springs 772 or 774 to move the locking assembly 742 between the locked and unlocked positions. From the unlocked position, the actuator 772 is energized so that the slider 748 is moved in the direction of arrow “M” to the locked position, and from the locked position the actuator 774 is energized so that the slider 748 is moved in the direction of arrow “N” to the unlocked position.

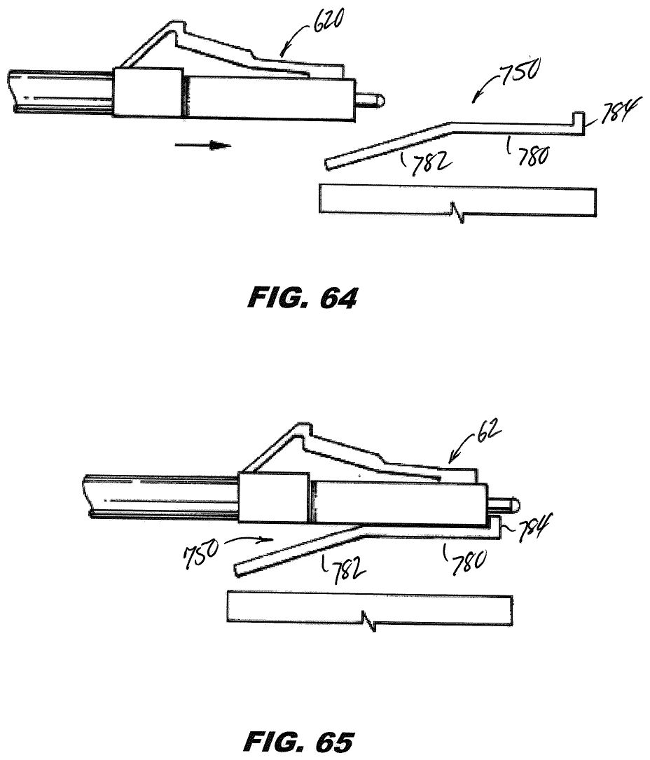

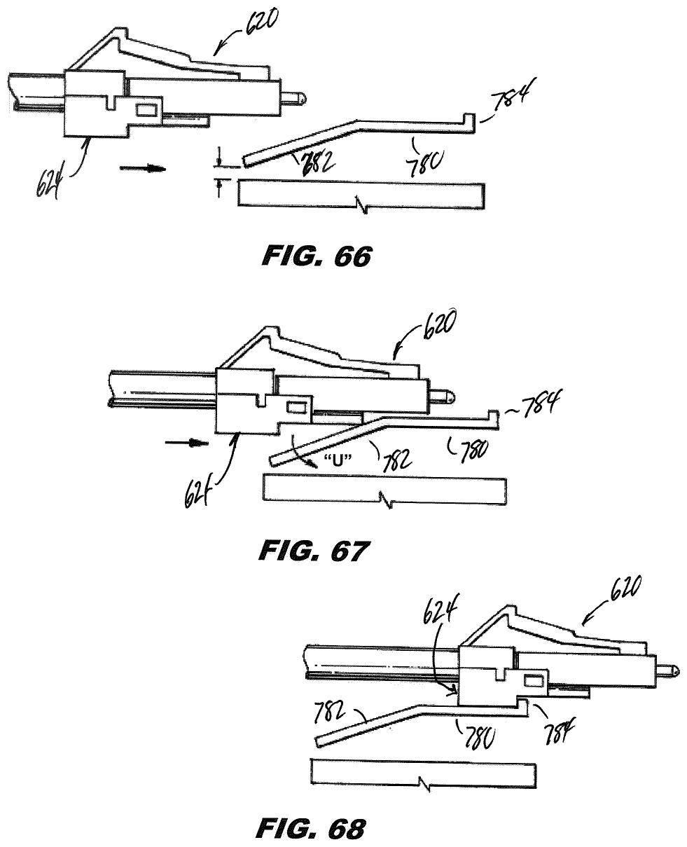

Referring now to FIGS. 63-68, the connector blocker 750 has a main portion 780, a flex portion 782 and a blocking portion 784. The connector blocker 750 is provided to block connectors that do not include the fiber mating assembly 730 according to the present disclosure. The connector blocker 750 is positioned within the channel 756 in the housing 744 so that the connector blocker 750 is in a fixed position relative to the housing 744. In operation, when a connector 620 without the media interface housing 624 of the fiber mating assembly 730 is inserted into the port 740, seen in FIGS. 64 and 65, the media interface housing 624 of the connector 620 does not contact the flex portion 782 of the connector blocker 750 so that the main portion 780 of the connector blocker 750 does not flex. As a result, the blocking portion 750 blocks the connector 620 from moving further into the housing 744 of the port 740, as shown in FIG. 65. When a connector 620 with the media interface housing 624 of the fiber mating assembly 730 is inserted into the port 740, seen in FIGS. 66-68, the media interface housing 624 of the connector 620 contacts the flex portion 782 of the connector blocker 750 causing the main portion 780 of the connector blocker 750 to flex as shown by arrow “U” in FIG. 67. The movement of the main portion 780 of the connector blocker 750 causes the blocking portion 784 to move away from the connector 620 sufficient to permit the media interface housing 624 to pass the blocking portion 784 further into the housing 744 of the port 740.

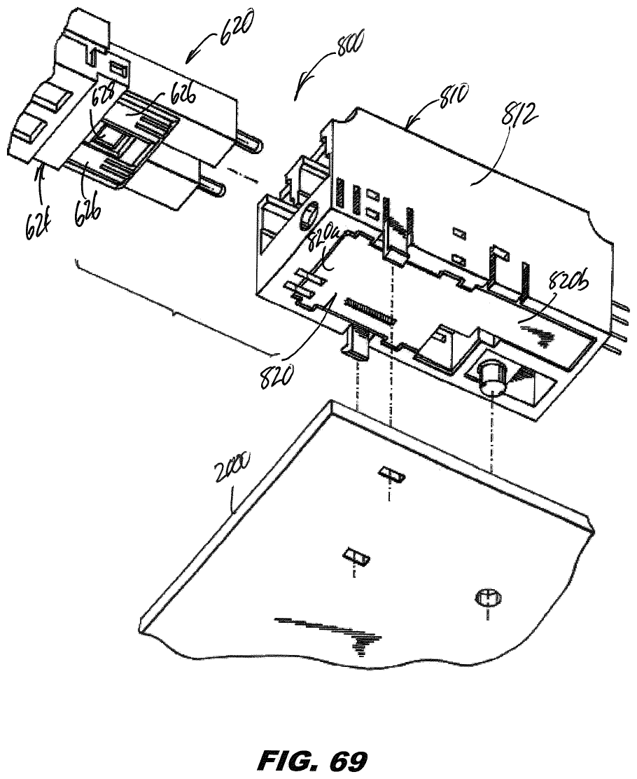

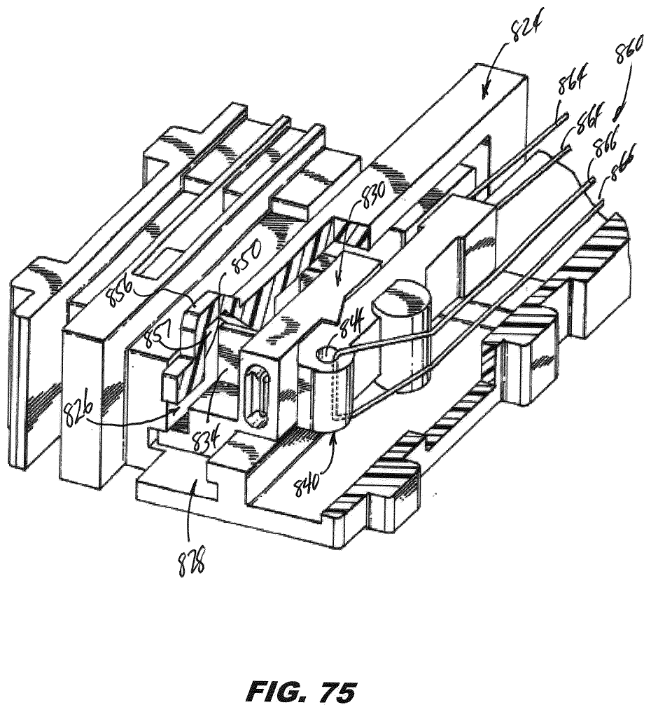

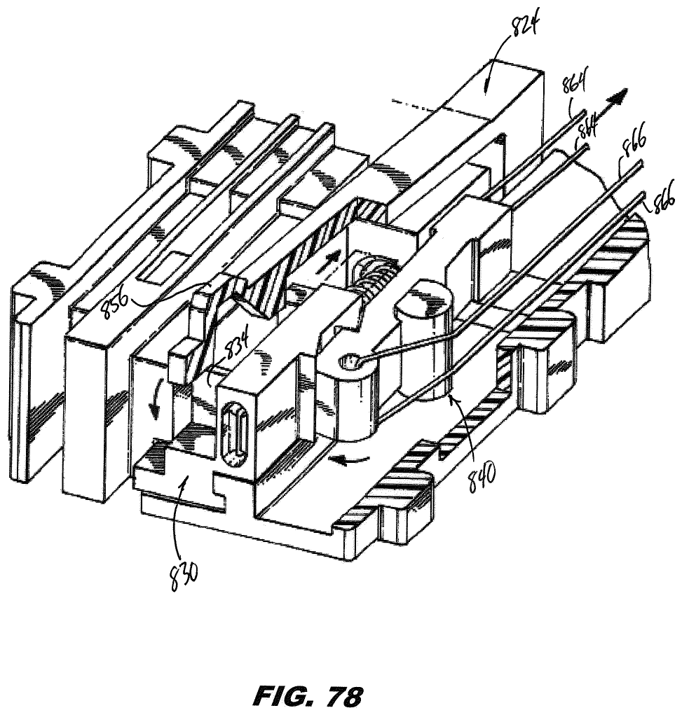

Referring now to FIGS. 69-78, another exemplary embodiment of a fiber mating assembly 800 is shown. The fiber mating assembly 800 may include a connector 620 and a fiber port 810. In the embodiment shown, the connector 620 includes a paired single fiber connector 620, seen in FIG. 69, (which are also known as a duplex connector), and the fiber port 810 includes paired single fiber ports. The fiber port 810 may also be referred to herein as the “port 810.” Each connector of the paired connector 620 is similar to, for example, known LC connectors that can be operatively connected to single fiber cables. The connector 620 may include a media interface housing 624 that is configured to receive one or more storage media 626, similar to the one or more storage media 626 described herein. In this exemplary embodiment, the one or more storage media 626 are electrical type storage media. Non-limiting examples of electrical type storage media include EEPROM's or other memory chips that can store information, or that can be programmed to store such information. The information stored on the storage media 626 includes, for example, identifying data and cable characteristics. Non-limiting examples of the connector identifying data and cable characteristics include connector ID, connector type, cable color, cable length, cable ID, cable fiber type, and any other desired information. A more detailed description of the media interface housing 624 is shown and described in commonly owned U.S. Pat. No. 11,650,380, which is incorporated herein in its entirety by reference. The media interface housing 624 also includes a locking opening 628, similar to the locking opening 628 described herein. The locking opening 628 is used when locking the connector 620 to the port 810 as described in more detail below. In another embodiment, the fiber mating assembly 800 may include a multi-fiber connector and a multi-fiber port that are similar to the multi-fiber connector and a multi-fiber port described hereinabove, such that the description above is applicable to this embodiment.

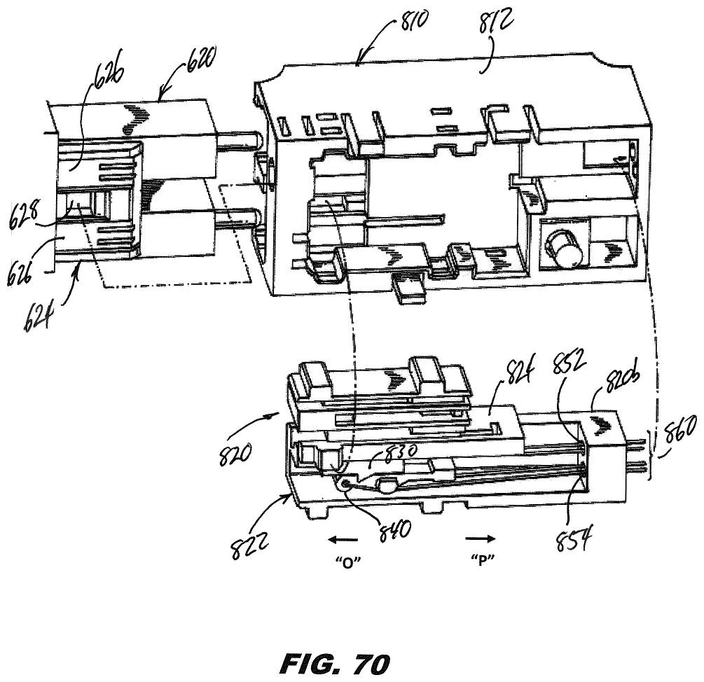

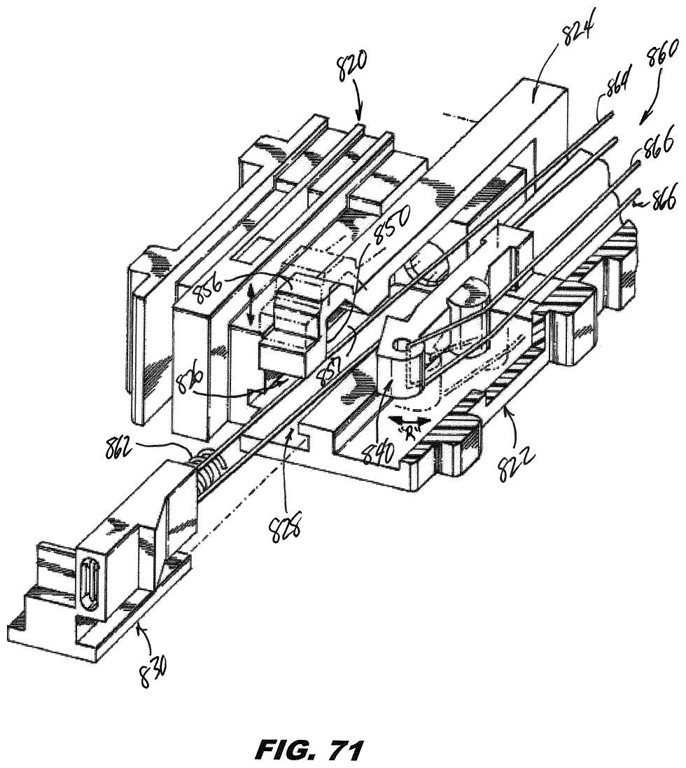

Continuing to refer to FIGS. 69-78, as noted, the port 810 is similar to, for example, known LC or MPO ports that can be operatively connected to a fiber connector 620, except the port 810 includes a locking assembly 820 attached to, e.g., releasably or permanently secured to, a housing 812 of the port 810. The port 810 may be mounted to a platform similar to platform 2000 described above. Non-limiting examples of a platform include printed circuit boards and surfaces of a housing or brackets within a housing of components within a datacenter. The locking assembly 820 includes a locking assembly body 822, a locking arm 824, a slider 830 and a slider latch 840. The locking assembly body 822 may include a slider holding portion 820a and an actuator holding portion 820b. The slider holding portion 820a includes a channel 826 configured and dimensioned to receive the locking arm 824 and the slider 830. Preferably, the locking arm 824 is fixed in position within the channel 826 in the body 822 and the slider 830 is longitudinally slidable within the channel 826 of the slider holding portion 820a. In this configuration, the slider 830 is positioned relative to the locking arm 824 so that the slider 830 is operatively associated with the locking arm 824. The actuator holding portion 820b is preferably integrally or monolithically formed into the slider holding portion 820a so that the actuator holding portion 820b is aligned with the channel 826 as shown in FIG. 71. However, the actuator holding portion 820b may be secured to the slider holding portion 820a using for example, welds, adhesives and/or mechanical fasteners such as a snap-fit connection. The actuator holding portion 820b is provided to hold or support at least a portion of an actuator 860, seen in FIG. 70, which is described in more detail below. In the embodiment shown, the actuator holding portion 820b includes one or more openings configured and dimensioned to receive at least a portion of the actuator 860. In the embodiment shown, the actuator holding portion 820b includes two openings 852 and 845.

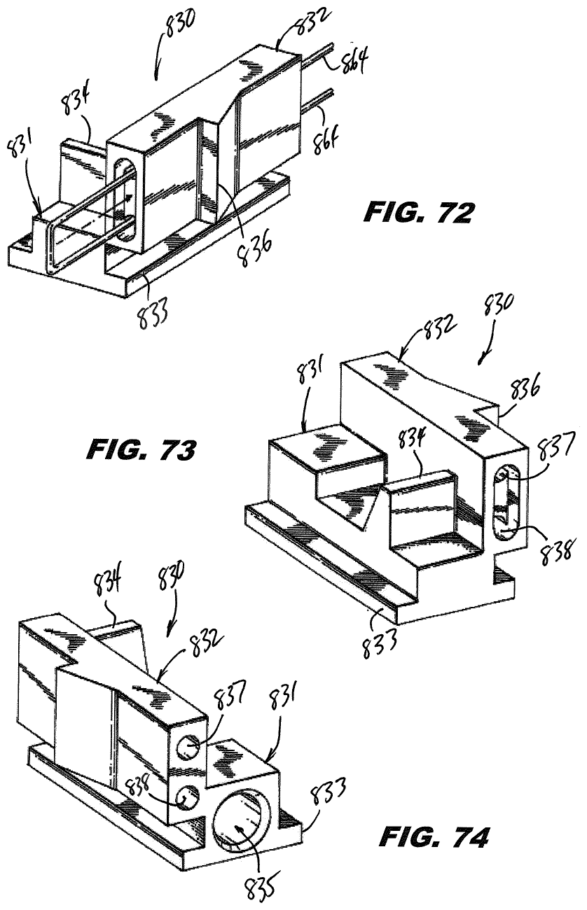

Referring to FIGS. 72-74, an exemplary embodiment of the slider 830 is shown. In the exemplary embodiment shown, the slider 830 has a main body 831 and a latch catch body 832. The main body 831 includes a rail 833 and a camming arm 834. The rail 833 is configured and dimensioned to be received in a track 828 in the slider holding portion 820a of the locking assembly body 822. In the exemplary embodiment shown, the rail 833 is a T-shaped rail and the track 828 is a T-shaped track configured to receive the T-shaped rail 833. The main body 831 also includes a recess 835 configured and dimensioned to receive at least a portion of the actuator 860. The camming arm 834 of the main body 831 extends in a direction toward the locking arm 824 such that the camming arm 834 contacts and rides along a camming surface 850, seen in FIG. 71, of the locking arm 824. The latch catch body 832 includes a catch 836 and one or more apertures extending therethrough. In the embodiment shown, there are two apertures 837 and 838 extending through the latch catch body 832. The apertures 837 and 838 are configured and dimensioned to receive at least a portion of the actuator 860. The apertures 837 and 838 are aligned with the apertures 852 and 854 in the actuator holding portion 820b of the locking assembly body 822.

In operation, the slider 830 is movable along the track 828 in the actuator holding portion 820a of the locking assembly body 822. As noted above, movement of the slider 830 along the track 828 in the direction of arrow “O” causes the camming arm 834 of the slider 830 to ride along the camming surface 850 of the locking arm 824 moving the locking member 856 of the locking arm 824 from an unlocked position to a locked position. Further, movement of the slider 830 along the track 828 in the direction of arrow “P” causes the camming arm 834 of the slider 830 to ride along the camming surface 850 of the locking arm 824 toward the space 857 in the locking arm 824 moving the locking member 856 of the locking arm 824 from the locked position to the unlocked position. As noted, when in the unlocked position, the locking member 856 of the locking arm 824 is removed from the opening 628 in the media interface housing 624, and when in the locked position, the locking member 856 of the locking arm 824 is positioned within the opening 628 in the media interface housing 624 preventing the connector 620 from being removed from the port 810 or preventing a connector 620 from being inserted into the port 810.

To move the slider 830 along the track 828, the actuator 860 may include a compression spring 862, seen in FIG. 71, that automatically moves the slider 830 in a direction of arrow “O” which is toward the locked position. The actuator 860 may also include wire leads 864 and 866 that can be made of a material having shape memory properties. For example, the wire leads 864 and 866 may be made of made of a material having shape memory properties, such as a shape memory alloy. Non-limiting examples of shape memory alloys include Nitinol, Flexinol® and Muscle Wire. The wire leads 864 and 866 would be electrically connected to the controller 750 and controlled by the controller as described herein. Thus, when the wire lead 864 is energized, the wire lead 864 is heated. Heating the wire lead 864 shrinks the wire lead so as to pull the slider 830 along the track 828 in the direction of arrow “P” to the unlocked position. When the wire lead 864 is deenergized, the wire lead 864 lengthens when cooled so that the compression spring 862 can push the slider 830 along the track 828 in the direction of arrow “O” to the locked position.

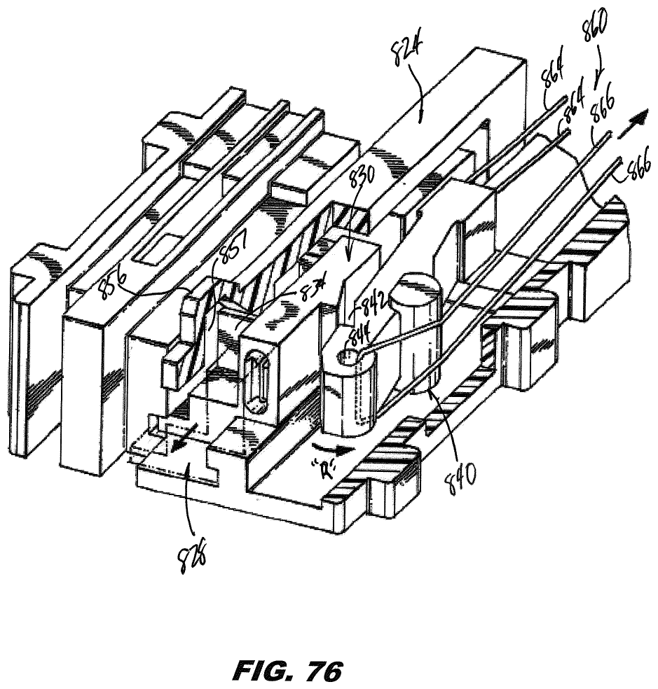

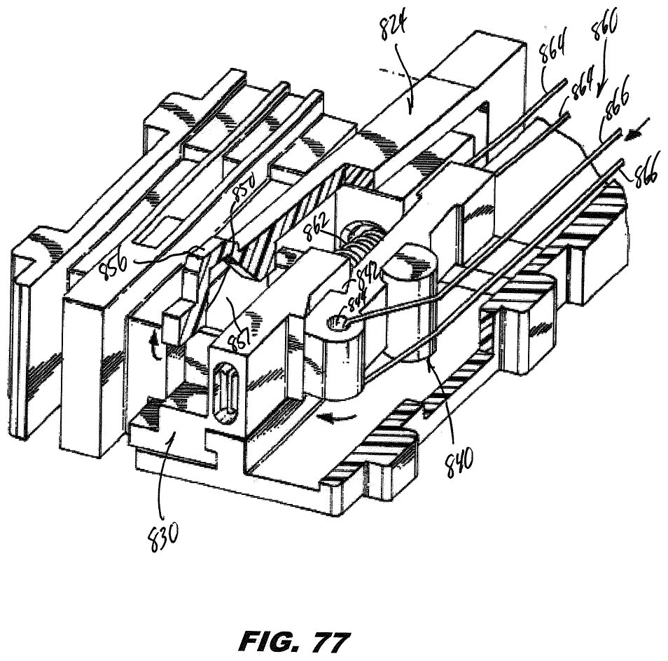

The slider latch 840 is movably, e.g., pivotably, secured within the slider holding portion 820a of the locking assembly body 822. The slider latch 840 includes a notch 842 adjacent to one end of the slider latch 840, as shown in FIGS. 76 and 77. The notch 842 is configured and dimensioned to receive the catch 836 extending from the slider 830. The same end of the slider latch 840 that has the notch 842 has an aperture 844 configured to receive a portion of the actuator system 860. Specifically, the actuator 860 may include a wire lead 866 that can be made of a material having shape memory properties. For example, the wire lead 866 may be made of a material having shape memory properties, such as a shape memory alloy. Non-limiting examples of shape memory alloys include Nitinol, Flexinol® and Muscle Wire. The wire lead 866 would be electrically connected to the controller 750 and controlled by the controller 750 as described herein. For example, when the wire lead 866 is energized the wire lead 866 is heated. Heating the wire lead 866 shrinks the wire lead so as to pull the slider latch 840 so the slider latch pivots in the direction of arrow “R” seen in FIG. 71. Pivoting the slider latch 840 releases the catch 836 extending from the slider 830 so that the slider 830 moves under the force of the compression spring 862 to the locked position. When the wire lead 866 cools, the wire lead 866 lengthens causing the slider latch 840 to pivot in a direction opposite the direction of arrow “R” so that the slider latch 840 is ready to receive the catch 836 extending from the slider 830.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A fiber cable mating system for selectively locking a comprising:
a port having an actuator assembly that selectively controls a locking pin to selectively move the locking pin between an unlocked position and a locked position; and
a fiber optic cable connector having a connector housing configured to receive at least a portion of the locking pin when the locking pin is in the locked position.
